(19) United States
(12) Patent Application Publication
(10) Pub. No.: US 2024/0198710 A1
(43) Pub. Date: Jun. 20, 2024

(54) INK JET RECORDING METHOD AND INK JET RECORDING APPARATUS

(71) Applicant: CANON KABUSHIKI KAISHA, Tokyo (JP)

(72) Inventors: ARIHIRO SAITO, Saitama (JP); TSUYOSHI KANKE, Kanagawa (JP); SHINYA YUMOTO, Kanagawa (JP)

(21) Appl. No.: 18/513,745

(22) Filed: Nov. 20, 2023

(30) Foreign Application Priority Data
Nov. 25, 2022 (JP) 2022-188258
Oct. 13, 2023 (JP) 2023-177417

(51) Int. Cl. B41M 5/50; B41M 7/00

(52) U.S. Cl. CPC B41M 5/502; B41M 7/0018

(57) ABSTRACT

Provided is an ink jet recording method capable of recording an image with suppressed unevenness when an image is recorded on a low absorbable recording medium by a single pass system. The method is an ink jet recording method for recording an image on a low absorbable recording medium using an aqueous ink and an aqueous reaction liquid containing a reactant reacting with the aqueous ink by carrying out application of the ink and the reaction liquid by a single pass system. The method includes an ink applying step to apply the reaction liquid to the recording medium, and a reaction liquid applying step to apply the ink to the recording medium so that a region to which the aqueous ink is applied and a region to which the reaction liquid is applied are at least partially overlap on the recording medium.

### BACKGROUND OF THE INVENTION

### Field of the Invention

The present invention relates to an ink jet recording method and an ink jet

recording apparatus.

### Description of the Related Art

An ink jet recording apparatus is an apparatus for recording an image on a recording medium by ejecting a fine ink droplet from an ejection orifice of a recording head. In recent years, it has been required to record an image on a recording medium having low aqueous ink absorbability or a recording medium that hardly absorbs an aqueous ink. Examples of the recording medium having low aqueous ink absorbability (hereinafter also referred to as “low absorbable recording medium”) include a recording medium having a coating layer, such as art paper and coated paper. Examples of the recording medium that hardly absorbs an aqueous ink (hereinafter also referred to as “non-absorbable recording medium”) include plastic films.

As the ink, the use of an aqueous ink containing a pigment (hereinafter also referred to as “pigment ink”) has been examined from the viewpoint of the environment and safety. So far, in a recording medium easily absorbing an aqueous ink, such as a recording medium having no coating layer such as plain paper, high definition image quality is obtained by using the pigment ink. Meanwhile, with respect to the low absorbable recording medium and the non-absorbable recording medium, the applied ink droplet hardly permeates the recording medium, so that the adjacent ink droplet is applied while the fixation of the ink by permeation is almost not occurring. As a result, ink droplets are joined together to cause bleeding or unevenness, so that high definition image quality is difficult to be obtained.

To address the above-mentioned challenge, a reaction liquid (also referred to as treatment liquid) containing a polyvalent metal salt that causes aggregation and thickening by reacting with the component in the ink, such as a pigment, is utilized (see Japanese Patent Application Laid-Open No. 2012-012443 and Japanese Patent Application Laid-Open No. 2012-233161).

In recent years, along with the speed-up of the recording speed, a method for recording an image by applying an ink to a recording medium by a so-called single (one) pass system has been examined to produce a large amount of recorded products in a short time. The single pass system refers to a system in which the application of a liquid such as an ink and a reaction liquid to a unit region on a recording medium is carried out by one relative scan between a recording head and the recording medium. In the recording by the single pass system, the image is recorded on the unit region on the recording medium by only one relative scan between the recording head and the recording medium.

The present inventors have carried out recording on a low absorbable recording medium by the single pass system using the reaction liquid and the ink suggested in Japanese Patent Application Laid-Open No. 2012-012443 and Japanese Patent Application Laid-Open No. 2012-233161. As a result, it has been found that when an image is recorded by applying the reaction liquid to the recording medium before the ink and then applying the ink to the recording medium by the single pass system, high density parts and low density parts are generated on the image and unevenness occurs on the image, in some cases.

Accordingly, an object of the present invention is to provide an ink jet recording method capable of recording an image with suppressed unevenness when an image is recorded on a low absorbable recording medium by a single pass system. In addition, another object of the present invention is to provide an ink jet recording apparatus.

### SUMMARY OF THE INVENTION

That is, according to the present invention, there is provided an ink jet recording method for recording an image on a recording medium having a water absorption amount of 4 mL/m² or more to 10 mL/m² or less from a start of contact to 30 msec^{1/2} in a Bristow method, using an aqueous ink, and an aqueous reaction liquid containing a reactant reacting with the aqueous ink by carrying out application of the aqueous ink and the reaction liquid to a unit region by one relative scan between an ejection head of an ink jet system and the recording medium, the method including a reaction liquid applying step to apply the reaction liquid to the recording medium, and an ink applying step to apply the aqueous ink to the recording medium so that a region to which the aqueous ink is applied and a region to which the reaction liquid is applied are at least partially overlap on the recording medium, wherein the aqueous ink contains a pigment, the reaction liquid contains a cationic resin having a structure of a quaternary ammonium salt, and a surface tension of a liquid obtained by replacing a surfactant in the reaction liquid with water at 25° C. is 60 mN/m or more.

Further features of the present invention will become apparent from the following description of exemplary embodiments with reference to the attached drawings.

### BRIEF DESCRIPTION OF THE DRAWINGS

FIG. 1 is a schematic view for illustrating an ink jet recording apparatus according to one embodiment of the present invention.

FIG. 2 is a perspective view for illustrating an example of a liquid applying device.

FIG. 3 is a sectional perspective view for illustrating an example of an ejection element substrate.

FIG. 4 is a schematic view for illustrating an example of a liquid supply system.

FIG. 5 is a schematic view for illustrating another example of a heating portion.

FIG. 6 is a schematic view for illustrating another example of a fixing portion.

### DESCRIPTION OF THE EMBODIMENTS

The present invention is described in more detail below by way of exemplary embodiments. In the present invention, when a compound is a salt, the salt is present as dissociated ions in an ink, but the expression “contain a salt” is used for convenience. In addition, an aqueous ink and reaction liquid for ink jet are sometimes referred to simply as “ink” and “reaction liquid”. Physical property values are values at normal temperature (25° C.), unless otherwise stated. The descriptions “(meth)acrylic acid” and “(meth)acrylate” refer to “acrylic acid or methacrylic acid” and “acrylate or methacrylate”, respectively. In the present invention, “unit” constituting a resin refers to a repeating unit derived from one monomer.

When an image is recorded by a two-liquid reaction system that uses a reaction liquid and an ink, the reaction liquid is typically applied to a recording medium and then the ink is applied. In the ink jet recording method of the present invention, the order of application of the reaction liquid and the ink is not limited to the above-mentioned order. However, the order in which the reaction liquid is applied to the recording medium and then the ink is applied is preferable because the effect of the present invention is more easily obtained. Hereinafter, the present invention will be described by way of the order in which the reaction liquid is applied to the recording medium and then the ink is applied.

The present inventors have examined to solve the image unevenness occurring when an image is recorded by using a reaction liquid and an ink and applying the reaction liquid and the ink to a low absorbable recording medium by the single pass system with an ink jet recording apparatus. First, to grasp the behavior of the reaction liquid and the ink on the recording medium, the state of the droplet after the reaction liquid and the ink have been applied to the recording medium has been observed. As a result, it has been found that the permeation into the recording medium is quickly started after the reaction liquid is applied to the recording medium. Since the reaction liquid present on the surface of the recording medium decreases due to the permeation of the reaction liquid into the recording medium, the reaction liquid applied to the recording medium is not sufficiently brought into contact with the ink applied to the recording medium later. Thus, the ink applied to the recording medium so that a region to which the aqueous ink is applied and a region to which the reaction liquid is applied are at least partially overlap on the recording medium lacks aggregation and remains on the surface of the recording medium in an insufficiently thickened state. Consequently, it is presumed that the convection of the ink occurred on the surface of the recording medium and the transfer of a pigment have caused the unevenness on the image.

In the recording by the single pass system, the recording of the image on a unit region is required to be carried out by one relative scan between a recording head and the recording medium. Thus, in the recording by the single pass system, a large amount of ink is applied at one time as compared with the recording by a multipass system in which the recording of the image is carried out by applying the reaction liquid and the ink to the recording medium dividedly in a plurality of times. Thus, it is considered that, it requires time for the ink to be thickened by being brought into contact with the reaction liquid, the convection of the ink on the surface of the recording medium easily occurs, and as a result, unevenness easily occurs on the image to be recorded.

The present inventors have considered that increasing the surface tension of the reaction liquid immediately after being applied to the recording medium is effective to suppress the permeation of the reaction liquid into the recording medium. At first, a reaction liquid having increased surface tension has been prepared by adjusting the amount of a surfactant, and the recording of the image has been carried out. However, immediately after the reaction liquid has been applied to the recording medium, a great part of the reaction liquid has permeated the recording medium, and the image unevenness has not been successfully suppressed.

Typically, in a liquid containing a surfactant that has a function of reducing surface tension when an interface is formed, the surface tension is reduced with time along with the orientation of the surfactant to the interface after the liquid is applied to an object such as a recording medium, that is, after an interface is formed.

The present inventors have confirmed the timing at which the reaction liquid permeates the low absorbable recording medium, and as a result, found that the permeation of the reaction liquid into the recording medium has been started before the surfactant has been oriented to the interface. The surface tension adjusted by using the surfactant indicates the surface tension after the surfactant has been oriented to the interface, that is, the surface tension after the permeation of the reaction liquid into the recording medium has already been started. Thus, it is presumed that the permeation of the reaction liquid immediately after being applied to the recording medium has not been successfully suppressed.

The present inventors have considered that it is important to increase the surface tension of the liquid immediately after the interface is formed, that is, before the surfactant is oriented to the interface, to suppress the permeation of the reaction liquid into the recording medium. In the present invention, the surface tension of the reaction liquid having a composition in which the surfactant is replaced with water is measured as a method for simulatively measuring the surface tension of the reaction liquid immediately after the interface formation.

Utilizing the above-mentioned measurement method, the present inventors have carried out the recording of an image by preparing a reaction liquid immediately after being applied to the recording medium, that is, a reaction liquid in which the surface tension of the liquid obtained by replacing the surfactant with water is increased, and examined. As a result, it has been found that the image unevenness is improved by setting the surface tension of the liquid obtained by replacing the surfactant in the reaction liquid with water at 25° ° C.to 60 mN/m or more. However, a target level has still not been achieved.

The present inventors have considered that suppressing the convection of the ink on the surface of the recording medium is effective to further improve the image unevenness, and considered that it is important to increase the viscosity upon mixing of the reaction liquid and the ink on the recording medium. As a result of the examination of the present inventors, it has been found that the viscosity of the mixture of the reaction liquid and the ink can be significantly increased by using a cationic resin having a structure of a quaternary ammonium salt as the reactant to be incorporated into the reaction liquid. The viscosity of the mixture of the reaction liquid and the ink is presumed to be rapidly increased due to that a network structure is formed by the interaction between an anionic component (such as an anionic group) contributing to the dispersion of the pigment in the ink and a cationic group of a cationic resin in the reaction liquid. Thus, suppressing the convection of the ink on the surface of the recording medium enables the image unevenness to be suppressed.

The above-mentioned image unevenness is a phenomenon particularly occurring in the case of using a low absorbable recording medium as the recording medium. As used herein, the low absorbable recording medium means a recording medium having a water absorption amount of 4 mL/m² or more to 10 mL/m² or less from the start of contact to 30 msec^{1/2} in the Bristow method. In the case of plain paper or the like which is a recording medium in which the permeation of the ink and the reaction liquid is relatively fast, the reaction liquid quickly permeates immediately after being applied to the recording medium, thereafter, the ink that has been applied to the recording medium is brought into contact with the reaction liquid, and then the pigment and the aqueous medium also permeate the recording medium while aggregating. Thus, since the convection of the ink does not occur on the surface of the recording medium, the pigment does not transfer so much, so that an image with suppressed unevenness can be obtained. Meanwhile, in the non-absorbable recording medium into which the ink and the reaction liquid hardly absorbed, since the reaction liquid hardly permeates, the reaction liquid and the ink are sufficiently brought into contact with each other on the surface of the non-absorbable recording medium, and the thickening of the ink sufficiently progresses. Thus, the convection of the ink hardly occurs and the image unevenness hardly occurs. As used herein, the non-absorbable recording medium means a recording medium having a water absorption amount of less than 4 mL/m² from the start of contact to 30 msec^{1/2} in the Bristow method. In addition, the absorbable recording medium means a recording medium having a water absorption amount of more than 10 mL/m² from the start of contact to 30 msec^{1/2} in the Bristow method.

<Ink Jet Recording Method and Ink Jet Recording Apparatus>

An ink jet recording method (hereinafter also simply referred to as “recording method”) of the present invention is a method for recording an image on a low absorbable recording medium (hereinafter sometimes referred to simply as “recording medium”) using an aqueous ink, and an aqueous reaction liquid containing a reactant reacting with the aqueous ink. In the recording method, an image is recorded by carrying out the application of the ink and the reaction liquid to a unit region on the recording medium using an ejection head of an ink jet system by one relative scan between the ejection head and the recording medium. The recording method includes a reaction liquid applying step to apply the reaction liquid to the recording medium, and an ink applying step to apply the ink to the recording medium so that a region to which the aqueous ink is applied and a region to which the reaction liquid is applied are at least partially overlap on the recording medium. In addition, an ink jet recording apparatus (hereinafter also simply referred to as “recording apparatus”) of the present invention is an apparatus to be used in the above-mentioned ink jet recording method.

The above-mentioned ink in the recording method and recording apparatus of the present invention contains a pigment. In addition, the above-mentioned reaction liquid in the recording method and recording apparatus of the present invention contains a cationic resin having a structure of a quaternary ammonium salt, and the surface tension of a liquid obtained by replacing the surfactant in the reaction liquid with water at 25° C. is 60 mN/m or more. The above-mentioned recording medium in the recording method and recording apparatus of the present invention is a recording medium having a water absorption amount of 4 mL/m² or more to 10 mL/m² or less from the start of contact to 30 msec^{1/2} in the Bristow method.

(Ink Jet Recording Apparatus)

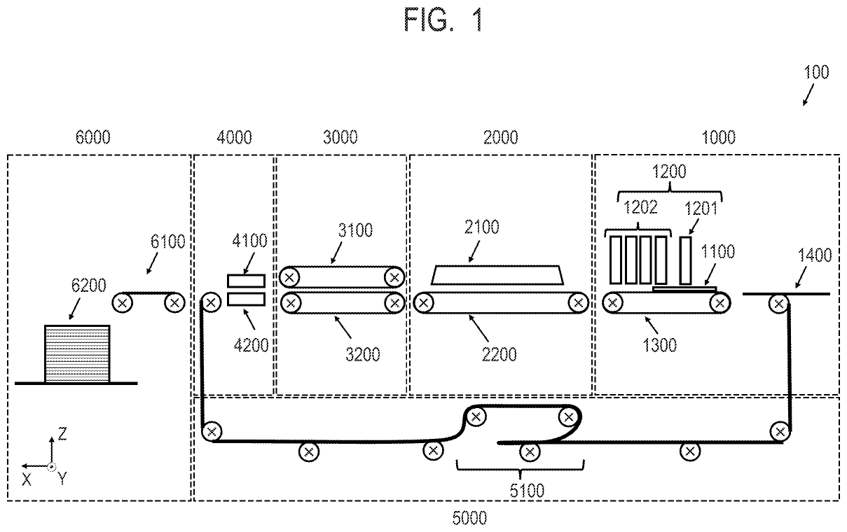

Details about the ink jet recording apparatus are described below with reference to the drawings. FIG. 1 is a schematic view for illustrating the ink jet recording apparatus according to one embodiment of the present invention. The ink jet recording apparatus of this embodiment is an ink jet recording apparatus that records an image on a recording medium with a reaction liquid containing a reactant that reacts with an ink and the ink. An X-direction, a Y-direction and a Z-direction represent the width direction (total length direction), depth direction and height direction of the ink jet recording apparatus, respectively. The recording medium is conveyed in the X-direction.

An ink jet recording apparatus 100 of the embodiment illustrated in FIG. 1 includes: a recording portion 1000; a heating portion 2000; a fixing portion 3000; a cooling portion 4000; a reversing portion 5000; and a sheet delivery portion 6000. In the recording portion 1000, various liquids are applied to a recording medium 1100, which has been conveyed from a sheet feeding device 1400 by a conveying member 1300, by a liquid applying device 1200. In the heating portion 2000, the heating of the liquids applied to the recording medium 1100 by a heating device 2100 evaporates volatile components in the liquids such as moisture, to thereby dry the liquids. In the fixing portion 3000, a fixing member 3100 is brought into contact with the region of the recording medium 1100 having applied thereto the liquids to heat the region, to thereby accelerate the fixation of an image to the recording medium 1100. After that, the recording medium 1100 is cooled by the cooling member 4100 of the cooling portion 4000. When an image is to be recorded on the rear surface of the recording medium subsequently to the front surface (recording surface) thereof, first, the recording medium 1100 is reversed by the reversing device 5100 of the reversing portion 5000. Next, after the image has been recorded on the rear surface as in the case of the front surface, the recording medium is conveyed by the conveying member 6100 of the sheet delivery portion 6000 and is loaded and stored in a recording medium storage portion 6200.

[Recording Portion]

The recording portion 1000 includes the liquid applying device 1200. The liquid applying device 1200 includes a reaction liquid applying device 1201 and an ink applying device 1202. As the reaction liquid applying device 1201, an ejection head of an ink jet system is used. The reaction liquid may be applied by the reaction liquid applying device 1201 before the application of the ink or may be applied after the ink application as long as the liquid can be brought into contact with the ink on the recording medium 1100. However, to record a high-quality image on various recording mediums having different liquid-absorbing characteristics, the reaction liquid is preferably applied before the application of the ink. An ejection head (recording head) of an ink jet system is used as the ink applying device 1202. Examples of the ejection system of the ejection head serving as the liquid applying device 1200 may include: a system including causing film boiling in a liquid with an electro-thermal converter to form air bubbles, to thereby eject the liquid; and a system including ejecting the liquid with an electro-mechanical converter. The reaction liquid permeates the recording medium with a lapse of time after being applied to the recording medium. Thus, as the time from the application of the reaction liquid to the application of the ink is short, the reaction liquid and the ink are easily brought into contact with each other, and the image unevenness is easily suppressed. Thus, the time from the application of the reaction liquid to the recording medium in the reaction liquid applying step to apply the ink to the recording medium in the ink applying step is preferably 1,100 msec or less. The time is preferably 100 msec or more, more preferably 500 msec or more.

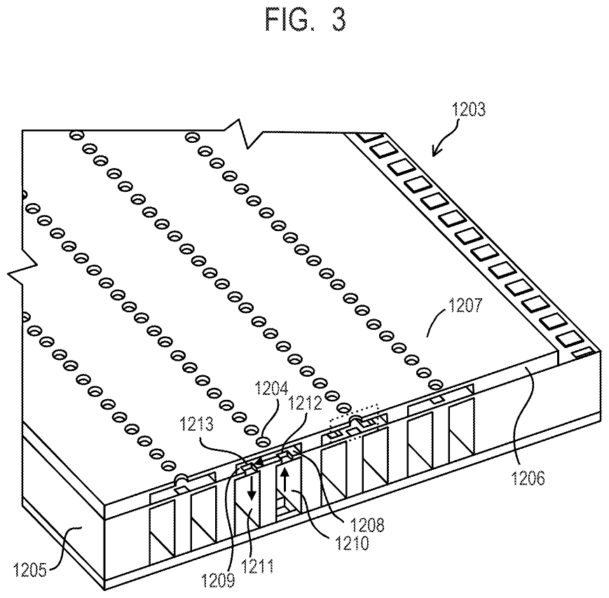

The liquid applying device 1200 is a line head arranged in the Y-direction in an extended manner and its ejection orifices are arrayed in a range covering the image recording region of the recording medium having the maximum usable width. The ejection head has an ejection orifice surface 1207 (FIG. 3) having formed therein ejection orifices on its lower side (recording medium 1100 side). The ejection orifice surface faces the recording medium 1100 with a minute distance of about several millimeters therebetween.

The plurality of ink applying devices 1202 may be arranged for applying inks of respective colors to the recording medium 1100. For example, when respective color images are recorded with a yellow ink, a magenta ink, a cyan ink and a black ink, the four ink applying devices 1202 that eject the above-mentioned four kinds of inks are arranged side by side in the X-direction. The ink and the reaction liquid are hereinafter sometimes collectively referred to as “liquids”.

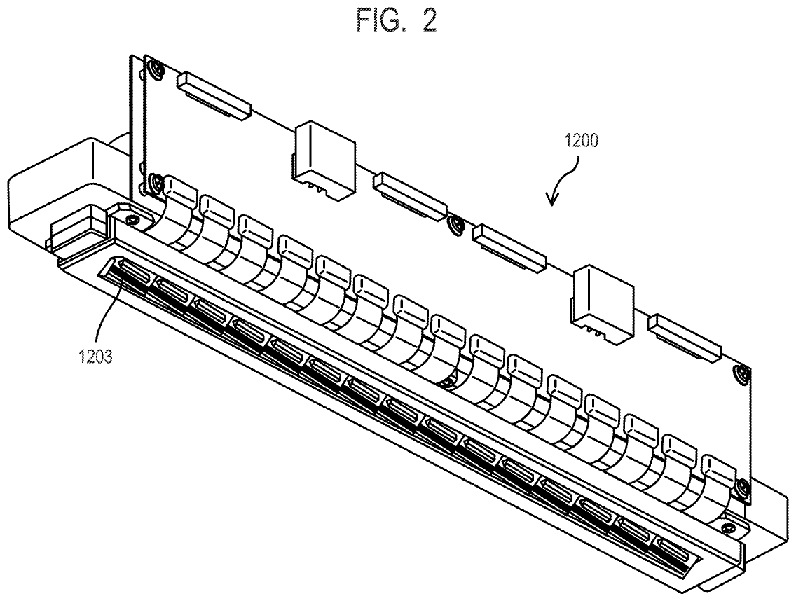

FIG. 2 is a perspective view for illustrating an example of the liquid applying device. The liquid applying device 1200 illustrated in FIG. 2 is a line head and a plurality of ejection element substrates 1203 having arranged therein ejection orifice arrays are linearly arrayed. The ejection element substrates 1203 each have arrayed therein a plurality of ejection orifice arrays.

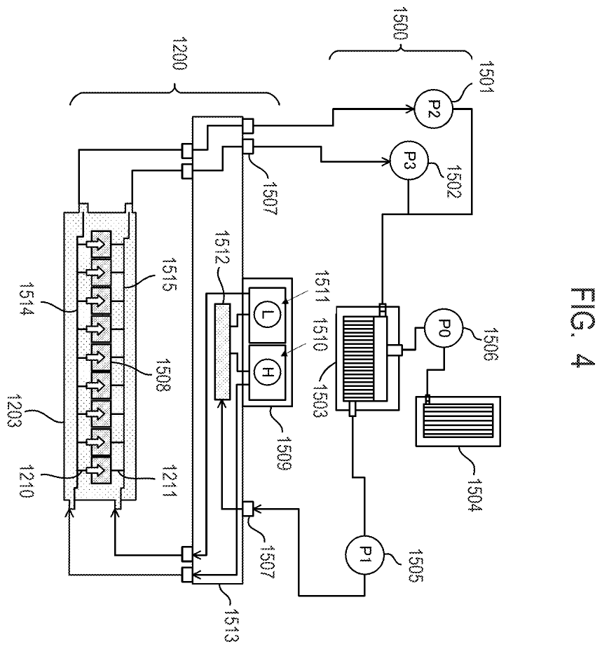

FIG. 3 is a sectional perspective view for illustrating an example of each of the ejection element substrates. The ejection element substrate 1203 illustrated in FIG. 3 includes: an ejection orifice forming member 1206 having opened therein ejection orifices 1204; and a substrate 1205 having arranged thereon an ejection element (not shown). The lamination of the ejection orifice forming member 1206 and the substrate 1205 forms a first flow path 1208 and a second flow path 1209 through which a liquid flows. The first flow path 1208 is a region from an inflow port 1212, into which the liquid flows from an inflow path 1210, to a portion between each of the ejection orifices 1204 and the ejection element (FIG. 4, a liquid chamber 1508). In addition, the second flow path 1209 is a region from the portion between the ejection orifice 1204 and the ejection element (FIG. 4, the liquid chamber 1508) to an outflow port 1213 from which the liquid flows out to an outflow path 1211. For example, when a pressure difference is made between the inflow port 1212 and the outflow port 1213 like the inflow port 1212 having a high pressure and the outflow port 1213 having a low pressure, the liquid can be flowed from the high pressure to the low pressure (in a direction indicated by the arrows in FIG. 3). The liquid that has passed the inflow path 1210 and the inflow port 1212 enters the first flow path 1208. Then, the liquid that has gone through the portion between the ejection orifice 1204 and the ejection element (FIG. 4, the liquid chamber 1508) flows to the outflow path 1211 via the second flow path 1209 and the outflow port 1213.

[Supply System]

FIG. 4 is a schematic view for illustrating an example of a supply system for the liquids such as the ink. A supply portion 1500 of the liquid applying device 1200 illustrated in FIG. 4 includes: a first circulation pump (high-pressure side) 1501; a first circulation pump (low-pressure side) 1502; a sub tank 1503; and a second circulation pump 1505. The sub tank 1503 connected to a main tank 1504 serving as a liquid storage portion has an air communication port (not shown) and hence can discharge air bubbles mixed into a liquid to the outside of a circulation system. The sub tank 1503 is also connected to a replenishment pump 1506. A liquid is consumed in the liquid applying device 1200 by the ejection (discharge) of the liquid from an ejection orifice in, for example, image recording or suction recovery. The replenishment pump 1506 transfers the liquid corresponding to the consumed amount from the main tank 1504 to the sub tank 1503.

The first circulation pump (high-pressure side) 1501 and the first circulation pump (low-pressure side) 1502 each flow the liquid in the liquid applying device 1200 that has been flowed out of a connection portion (inflow portion) 1507 to the sub tank 1503. A positive-displacement pump having a quantitative liquid-delivering ability is preferably used as each of the first circulation pump (high-pressure side) 1501, the first circulation pump (low-pressure side) 1502 and the second circulation pump 1505. Examples of such positive-displacement pump may include a tube pump, a gear pump, a diaphragm pump and a syringe pump. At the time of the driving of each of the ejection element substrates 1203, the liquid can be flowed from a common inflow path 1514 to a common outflow path 1515 by the first circulation pump (high-pressure side) 1501 and the first circulation pump (low-pressure side) 1502.

A negative pressure control unit 1509 includes two pressure adjusting mechanisms in which control pressures different from each other are set. A pressure adjusting mechanism (high-pressure side) 1510 and a pressure adjusting mechanism (low-pressure side) 1511 are connected to the common inflow path 1514 and the common outflow path 1515 in the ejection element substrate 1203 via a supply unit 1513 having arranged therein a filter 1512 that removes foreign matter from a liquid, respectively. The ejection element substrate 1203 has arranged therein the common inflow path 1514, the common outflow path 1515, and the inflow path 1210 and the outflow path 1211 that communicate to the liquid chamber 1508 serving as a portion between each of the ejection orifices 1204 and the ejection element (not shown). The inflow path 1210 and the outflow path 1211 communicate to the common inflow path 1514 and the common outflow path 1515, respectively. Accordingly, a flow (arrow in FIG. 4) in which part of the liquid passes the inside of the liquid chamber 1508 from the common inflow path 1514 to flow to the common outflow path 1515 occurs. The arrows in FIG. 3 indicate the flow of the liquid in the liquid chamber 1508. That is, as illustrated in FIG. 3, the liquid in the first flow path 1208 flows to the second flow path 1209 via a space between the ejection orifice 1204 and the ejection element.

As illustrated in FIG. 4, the pressure adjusting mechanism (high-pressure side) 1510 is connected to the common inflow path 1514 and the pressure adjusting mechanism (low-pressure side) 1511 is connected to the common outflow path 1515. Accordingly, a pressure difference occurs between the inflow path 1210 and the outflow path 1211. Thus, a pressure difference also occurs between the inflow port 1212 (FIG. 3) communicating to the inflow path 1210 and the outflow port 1213 (FIG. 3) communicating to the outflow path 1211. When a liquid is flowed by the pressure difference between the inflow port 1212 and the outflow port 1213, the flow rate (mm/s) of the liquid is preferably controlled to 0.1 mm/s or more to 10.0 mm/s or less.

[Conveyance System]

As illustrated in FIG. 1, the recording portion 1000 includes the liquid applying device 1200 and the conveying member 1300 that conveys the recording medium 1100. The reaction liquid and the ink are applied to the desired positions of the recording medium 1100, which is conveyed by the conveying member 1300, by the liquid applying device 1200. The respective liquid applying devices receive the image signal of recording data to apply the required reaction liquid and ink to the respective positions. Although the conveying member 1300 in the form of a conveying belt is illustrated in FIG. 1, for example, a spur or a conveying cylinder may be utilized as long as the spur or the cylinder has a function of conveying the recording medium 1100. A member that can fix the recording medium 1100 may be used as the conveying member 1300 for improving conveyance accuracy. Specific examples thereof may include: an approach including arranging holes in the conveying member 1300 and sucking the recording medium 1100 from its rear surface side to fix the medium; and an approach including forming the conveying member 1300 from an appropriate material and electrostatically adsorbing the recording medium 1100 to fix the medium.

[Heating Portion]

As illustrated in FIG. 1, the heating portion 2000 includes the heating device 2100 and a conveying member 2200. The recording medium 1100 having recorded thereon the image through the application of the reaction liquid and the ink is heated by the heating device 2100 while being conveyed by the conveying member 2200. Thus, the liquid components of the image are evaporated and dried. The recording method preferably further includes, between the ink applying step and the fixing step, a drying step of subjecting the recording medium having applied thereto the ink to non-contact heating to dry the ink. The presence of such drying step can effectively suppress the deformation (cockling or curl) of the recording medium 1100.

The heating device 2100 may have any configuration as long as the device can heat the recording medium 1100. Conventionally known various devices, such as a warm-air dryer and a heater, may each be used. Of those, a non-contact-type heater, such as a heating wire and an infrared heater, is preferably utilized in terms of safety and energy efficiency. In addition, the utilization of the following mechanism easily improves the drying efficiency and easily suppresses image unevenness, the mechanism has built therein a fan for jetting a heated gas on the recording medium 1100 and blows warm air thereto.

With regard to a method for the heating, the recording medium 1100 may be heated from the side of the surface (recording surface (front surface)) having applied thereto the reaction liquid and the ink, may be heated from its rear surface side or may be heated from both the surfaces. A heating function may be imparted to the conveying member 2200. Although the conveying member 2200 utilizing a conveying belt are illustrated in FIG. 1, for example, a spur or a conveying cylinder may be utilized as long as the spur or the cylinder has a function of conveying the recording medium 1100. From the viewpoint of suppressing the deformation of the recording medium 1100 by the heating, a configuration, which blows air from the heating portion 2000 to convey the recording medium 1100 while bringing the medium into close contact with the conveying member 2200, or a mechanism that fixes the recording medium to the conveying member 2200 is preferably arranged. Specific examples thereof may include: an approach including arranging holes in the conveying member 2200 and sucking the recording medium 1100 from its rear surface side to fix the medium; and an approach including forming the conveying member 2200 from an appropriate material and electrostatically adsorbing the recording medium 1100 to fix the medium.

A heating temperature is preferably set so that a liquid component may be quickly evaporated and so that the recording medium 1100 may not be overdried from the viewpoint of suppressing the deformation of the recording medium 1100. In view of a conveying speed and an environmental temperature, the temperature of a drying unit may be set so that the recording medium may have a desired temperature. Specifically, the temperature of the drying unit (e.g., warm air) is set to preferably 40° C. or more to 100° C. or less, more preferably 60° C. or more to 80° C. or less. In addition, when a heated gas is blown to heat the recording medium 1100, an air speed is preferably set to 1 m/s or more to 100 m/s or less. The temperature of air such as warm air may be measured with a K-type thermocouple thermometer. A measuring machine may be specifically, for example, a machine available under the product name “AD-5605H” (manufactured by A&D Company, Limited).

(Drying Step)

The recording method of the present invention preferably includes a drying step to dry the recording medium to which the reaction liquid and the ink are applied by using the heating device 2100. The drying unit in the drying step is more preferably warm air having an air speed of 40 m/s or less. When the air speed of warm air is 40 m/s or less, the transfer of the image due to air pressure is reduced and the image unevenness can be further suppressed. The air speed of warm air is preferably 10 m/s or more, more preferably 20 m/s or more.

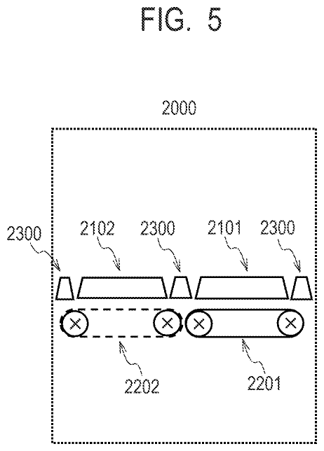

FIG. 5 is a schematic view for illustrating another example of the heating portion. Herein, a difference from the heating portion described in FIG. 1 and the foregoing is described. The heating portion 2000 illustrated in FIG. 5 includes: a first heating device 2101 and a second heating device 2102; and a first conveying member 2201 and a second conveying member 2202 arranged to face the first heating device 2101 and the second heating device 2102, respectively.

A mechanism that sucks and fixes the recording medium 1100 is not arranged in the first conveying member 2201. In addition, warm air from the first heating device 2101 presses the recording medium 1100 against the first conveying member 2201, to thereby convey the recording medium 1100. Thus, the recording medium 1100 can be delivered from the conveying member 1300 (FIG. 1) to the first conveying member 2201 and from the first conveying member 2201 to the second conveying member 2202 with high accuracy. Further, a conveyance shift due to a slight difference in conveying speed between the conveying member 1300 (FIG. 1) and the first conveying member 2201 can be reduced. Meanwhile, a conveying belt having arranged therein holes that can pass a gas therethrough is utilized as the second conveying member 2202 and the recording medium 1100 is conveyed while being fixed to the second conveying member 2202 via a suction mechanism (not shown).

Air knives 2300 are arranged between the conveying member 1300 (FIG. 1) and the first conveying member 2201, between the first conveying member 2201 and the second conveying member 2202 and between the second conveying member 2202 and a conveying member 3200 (FIG. 1), respectively. The lifting of the tip portion of the recording medium 1100, which has been conveyed, is pressed down with an air pressure from the air knives 2300. Thus, the collision of the tip portion of the recording medium 1100 with the first heating device 2101, the second heating device 2102 and the fixing member 3100 (FIG. 1) is avoided and hence the occurrence of a conveyance failure can be suppressed.

The first heating device 2101 and the second heating device 2102 may each have the same configuration as that of the above-mentioned heating device 2100. The temperatures of the first heating device 2101 and the second heating device 2102 may be identical to or different from each other. The air speeds of heated gases when the gases are blown from the devices to heat the recording medium may also be identical to or different from each other. In addition, the medium may be heated from the first conveying member 2201 and the second conveying member 2202 as required.

[Fixing Portion]

As illustrated in FIG. 1, the fixing portion 3000 is a contact-type heating and pressurizing mechanism including the fixing member 3100 serving as a fixing belt such as an endless belt and the conveying member 3200. In the fixing portion 3000, the recording medium 1100 is conveyed by the conveying member 3200. In addition, the fixing member 3100 is brought into contact with the recording medium 1100 under a state in which the medium is pressurized to heat the liquids applied to the recording medium 1100, such as the reaction liquid and the ink. Thus, an image can be fixed to the recording medium 1100. After the permeation of the liquid components of the reaction liquid and the ink into the recording medium 1100 having recorded thereon the image and the evaporation thereof from the recording medium 1100 by their passing through the heating portion 2000, the reaction liquid and the ink are fixed in the fixing portion 3000 to complete the image. When the recording medium 1100 is heated and pressurized under the state of being sandwiched between the fixing member 3100 and the conveying member 3200, the image on the recording medium 1100 and the fixing member 3100 are brought into close contact with each other and hence the image is fixed to the recording medium 1100. When a liquid such as an ink containing the resin particle and a coloring material is used, the resin particle is softened through heating mainly by the fixing portion 3000 to form a film and hence the coloring material can be bound onto the recording medium 1100.

A method of heating the fixing member 3100 may be, for example, a system including arranging a heat source such as a halogen heater in each of rollers that drive the fixing member 3100 serving as a fixing belt to heat the member. In addition, the method may be, for example, a system including arranging a heat source such as an infrared heater at a site different from the fixing member 3100 to heat the member. Further, those systems may be combined with each other. The conveying member 3200 may be heated as required. In view of a conveying speed and an environmental temperature, the temperature of the fixing member 3100 may be set so that the surface of the recording medium may have a desired temperature. Specifically, the temperature of the fixing member 3100 is set to preferably 50° C. or more to 120° C. or less, more preferably 60° C. or more to 110° C.or less. The temperature of the contact-type heating and pressurizing mechanism (fixing member 3100) and the surface temperature of the recording medium immediately after its passing through the contact-type heating and pressurizing mechanism may each be measured with a radiation thermometer. The radiation thermometer only needs to be arranged near an end portion (terminal) of the contact-type heating and pressurizing mechanism. The radiation thermometer may be specifically, for example, a thermometer available under the product name “RADIATION THERMOMETER IT-545S” (manufactured by Horiba, Ltd.).

In the case where the ink includes the resin particle, when the temperature of the fixing member 3100 is set to a temperature equal to or more than the glass transition temperature of the resin particle in the ink, the resin particle easily softens to form a film and hence the abrasion resistance of the image can be improved. When the ink includes a wax particle, the temperature of the fixing member 3100 is preferably set to be lower than the melting point of a wax for forming the wax particle. Thus, the wax that is suppressed from melting easily remains on the surface of the image and hence the abrasion resistance of the image can be improved.

A nip pressure between the fixing member 3100 and the conveying member 3200, that is, a pressure to be applied to the recording medium when the medium passes the contact-type heating and pressurizing mechanism is set to preferably 10 Pa or more to 1,000 Pa or less, more preferably 10 Pa or more to 500 Pa or less. In addition, the pressure is particularly preferably set to 10 Pa or more to 400 Pa or less. A time period (nip time) required for the recording medium to pass the contact-type heating and pressurizing mechanism is preferably 0.25 second or more to 5.0 seconds or less, more preferably 0.5 second or more to 4.0 seconds or less, particularly preferably 1.0 second or more to 3.0 seconds or less.

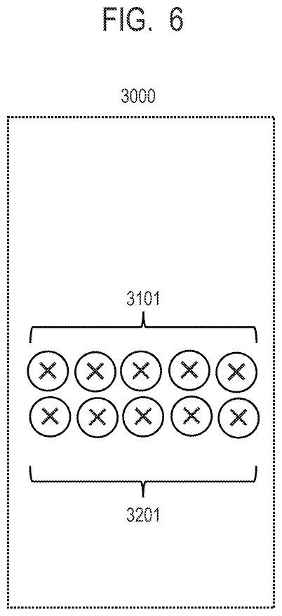

FIG. 6 is a schematic view for illustrating another example of the fixing portion. Herein, a difference from the fixing portion described in FIG. 1 and the foregoing is described. The fixing portion 3000 illustrated in FIG. 6 is a contact-type heating and pressurizing mechanism including a plurality of fixing rollers 3101 and a plurality of conveying members 3201 arranged to face these fixing rollers 3101. When the recording medium 1100 having applied thereto the liquids such as the ink passes a space between the fixing rollers 3101 and the conveying members 3201, an image is fixed to the recording medium. The extent to which the image is fixed to the recording medium may be adjusted by controlling, for example, the numbers of the fixing rollers 3101 and the conveying members 3201, the time period for which the recording medium is nipped by the rollers and the members, a temperature and a pressure.

[Cooling Portion]

The cooling portion 4000 includes the cooling member 4100 and a conveying member 4200 (FIG. 1). The cooling portion 4000 cools the recording medium 1100 that has passed the heating portion 2000 and the fixing portion 3000 to have a high temperature. The cooling member 4100 may have any configuration as long as the member can cool the recording medium 1100. Approaches, such as air cooling and water cooling, may each be utilized. Of those, an approach including blowing a gas that is not heated is preferred in terms of safety and energy efficiency. In addition, the utilization of the following mechanism easily improves cooling efficiency: the mechanism has built therein a fan for jetting a gas on the recording medium 1100 and blows air thereto. In view of a conveying speed and an environmental temperature, the temperature of a cooling unit may be set so that the image of the recording medium may have a desired temperature. Specifically, the temperature of the cooling unit (e.g., blowing) is set to preferably 20° C. or more to 60° C. or less, more preferably 25° C. or more to 50° C. or less. When a gas is blown to cool the recording medium, its air speed is preferably set to 1 m/s or more to 100 m/s or less. The adoption of such conditions can suppress the deformation of the recording medium 1100 to be loaded in the sheet delivery portion 6000 to be described later and the sticking (blocking) of the image.

[Reversing Portion]

When double-sided recording is performed, the recording medium 1100 is reversed through utilization of the reversing portion 5000 (FIG. 1). The recording medium 1100 having the image recorded on its recording surface (front surface) passes the cooling portion 4000 and is then diverged and conveyed, followed by reversal by a reversing device 5100. The recording medium 1100 that has been reversed is conveyed to the sheet feeding device 1400 of the recording portion 1000 under a state in which the liquids are applied to its rear surface (surface opposite to the recording surface (front surface)).

[Sheet Delivery Portion]

The recording medium 1100 after the image recording is stored in the sheet delivery portion 6000 (FIG. 1). The recording medium 1100 that has passed the cooling portion 4000 after the performance of single-sided recording or double-sided recording is conveyed by the conveying member 6100 to be finally stored under the state of being loaded in the recording medium storage portion 6200. The two or more recording medium storage portions 6200 may be arranged for, for example, separately storing different recorded products.

(Recording Medium)

As the recording medium, a recording medium having low aqueous ink absorbability (low absorbable recording medium) is used. As mentioned above, the low absorbable recording medium is the recording medium having a water absorption amount of 4 mL/m² or more to 10 mL/m² or less from the start of contact to 30 msec^{1/2} in the Bristow method. The Bristow method is described in “Paper and Paperboard, liquid absorbability testing method” in the JAPAN TAPPI paper pulp testing method No. 51. Examples of the low absorbable recording medium include a recording medium having no ink receiving layer, such as uncoated paper and synthetic paper, and a recording medium having an ink receiving layer such as a recording medium having a thin ink receiving layer. Specific examples of the recording medium include art paper, high-quality coated paper, medium-quality coated paper, high-quality light weight coated paper, medium-quality light weight coated paper, slightly coated paper, cast-coated paper and actual printing stock. The basis weight (g/m²) of the recording medium 1100 is preferably 30 g/m² or more to 500 g/m² or less, more preferably 50 g/m² or more to 450 g/m² or less.

<Reaction Liquid>

The recording method of the present invention preferably further includes a reaction liquid applying step to apply an aqueous reaction liquid, which contains a reactant that reacts with the aqueous ink, to the recording medium. Respective components to be used in the reaction liquid and the like are described in detail below.

[Reactant]

The reaction liquid is brought into contact with the ink to react with the ink, to thereby aggregate components (a resin, a surfactant, and a component having an anionic group such as a self-dispersible pigment) in the ink. The reaction liquid contains the reactant. When the reactant is present, at the time of contact between the ink and the reactant in the recording medium, the state of presence of the component having an anionic group in the ink is destabilized and hence the aggregation of the ink can be accelerated. The reaction liquid to be used in the recording method of the present invention contains a cationic resin having a structure of a quaternary ammonium salt (as used herein, sometimes referred to simply as “cationic resin”) as a reactant.

[Cationic Resin]

The cationic resin refers to a resin having a cationic moiety in the molecular chain. The reaction liquid to be used in the recording method of the present invention contains a cationic resin having a structure of a quaternary ammonium salt as the cationic moiety. Since the cationic resin serving as the reactant can stably maintain a cationic state by having a quaternary ammonium cation as the cationic moiety even when a pH change is caused by the contact with the ink, the cationic resin can easily interact with the anionic component in the ink.

As the counter anion of the cationic group of the cationic resin, a halide ion such as a chloride ion (Cl⁻) is preferable. The reason is because, although there are other counter anions such as ethyl sulfate ion (C₂H₅SO₄⁻), the halide ion is smaller in size than other counter anions and hardly prevents the interaction between the cationic moiety and the anionic component in the ink. Among halide ions, a chloride ion is particularly preferable.

The weight average molecular weight of the cationic resin is preferably 3,000 or more to 50,000 or less, more preferably 4,000 or more to 30,000 or less. When the weight average molecular weight of the cationic resin is 3,000 or more, preferably 4,000 or more, the viscosity of the mixture of the reaction liquid and the ink is increased and the effect of suppressing the image unevenness is further increased. On the other hand, when the weight average molecular weight of the cationic resin is 50,000 or less, suitably 30,000 or less, the mixed viscosity when being in contact with the ink is not too high, the roughness on the surface of the image to be recorded is suppressed, and the effect of suppressing the image unevenness is further increased. The weight average molecular weight of the cationic resin can be measured by gel permeation chromatography (GPC).

The structure of the quaternary ammonium salt of the cationic resin is preferably a unit represented by the following general formula (1). The unit represented by the general formula (1) is a unit derived from diallyldialkyl ammonium salt.

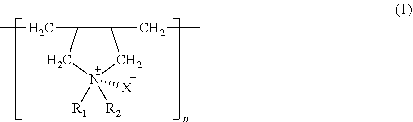

In the general formula (1), R₁ and R₂ each independently represent an alkyl group, X⁻ represents a counter anion of a quaternary ammonium cation, and n represents the number of repeating unit. The number of carbon atoms of the alkyl groups represented by R₁ and R₂ is preferably 1 or more to 6 or less, more preferably 1 or more to 3 or less. Of those, a methyl group and an ethyl group are more preferable. Examples of the counter anion represented by X⁻ include a chloride ion, a methyl sulfate ion and an ethyl sulfate ion. Of those, a chloride ion is preferable, as mentioned above. The number of repeating unit represented by n is preferably such a number that the weight average molecular weight of the cationic resin having a unit represented by the general formula (1) is within the above-mentioned range.

Among the units represented by the general formula (1), a unit derived from diallyldimethylammonium chloride in which R¹ and R² in the general formula (1) are each a methyl group and X⁻ is Cl⁻, is preferable. In addition, a unit derived from diallylmethylethylammonium ethyl sulfite in which R₁ in the general formula (1) is a methyl group, R₂ is an ethyl group and X⁻is C₂H₅SO₄⁻, and the like are preferable. Of those, the unit of diallyldimethylammonium chloride is more preferable. Since a quaternary ammonium cation is present at a side chain, the unit derived from diallyldimethylammonium chloride is hardly affected by steric hindrance as compared with the case where a quaternary ammonium cation is present at the main chain. Thus, the cationic resin can easily interact with the anionic component in the ink and the effect of suppressing the image unevenness is further increased.

The charge density (meq/g) of the cationic resin can be measured by the following procedure. The charge density is a value calculated from the amount of dropwise addition of the aqueous potassium polyvinyl sulfate solution required for obtaining the isoelectric point measured by a colloid titration method to the aqueous solution of the cationic resin at pH 7, and represents the amount of charge of the cationic resin per 1 g. The measurement method of the charge density can be carried out according to the method known as “colloid titration method”. The principle and the measurement method will be described below. In Examples described later, the charge density (meq/g) is measured by the following measurement method to determine the amount of the cationic group (mmol/g).

(Principle)

Toluidine blue (TB) is a basic pigment. Although TB is not adsorbed onto a positive colloid having an amino group, TB is immediately adsorbed onto a negative colloid and changes its color to red purple. Utilizing this phenomenon, for example, TB is added to an aqueous cationic resin solution, and a dilute solution of potassium polyvinyl sulfate (PVSK) is added dropwise. Then, PVSK preferentially reacts with the cationic group. TB does not change its color at first, but when PVSK exceeds the equivalence point, excess PVSK reacts with TB, and the solution changes its color from blue to red purple. By using TB as an indicator, the charge density can be calculated from the amount of consumption of PVSK.

(Measurement Method of Charge Density)

(1) A sample (0.05 to 0.15 g as a solid content) is precisely weighed into a 100 ml volumetric flask, and ion-exchanged water is added up to the marked line. (2) 10 mL of the aqueous sample solution is taken into a 50 mL beaker with a volumetric pipette. (3) The pH of the aqueous sample solution can be appropriately adjusted by adding a few drops of a dilute aqueous ammonium solution or an aqueous acetic acid solution. (4) The beaker is placed on a magnetic stirrer, a rotor is put, and the solution is stirred still. (5) When 2 to 3 drops of the aqueous TB solution are added, the solution exhibits blue (skyblue). (6) When 1/500 N PVSK is added dropwise from a 10 mL buret in the beaker, precipitation is caused at near the equivalence point and the solution becomes cloudy. (7) PVSK is further added dropwise, and when the liquid phase changes its color from blue to red purple, the dropwise addition of PVSK is stopped and the scale of the buret is read. The charge density is calculated from the following expression.

$$Charge density ( meq / g \cdot solid ) = \frac{V \times 1 / 500}{S \times ( N / 100 ) \times ( 10 / 100 )}$$

V: Amount of titration of aqueous solution of 1/500 N PVSK (mL)
S: Amount of sample collected (g)
N: Sample solid content (% by mass)

The content (% by mass) of the cationic resin having a structure of a quaternary ammonium salt (solid content) in the reaction liquid is preferably 0.10% by mass or more to 10.00% by mass or less with respect to the total mass of the reaction liquid. The above-mentioned content of the cationic resin is more preferably 0.20% by mass or more to 5.00% by mass or less, still more preferably 0.30% by mass or more to 3.00% by mass or less.

The reaction liquid may contain other reactants other than the above-mentioned cationic resin as required. Examples of other reactants include cationic components such as a polyvalent metal ion, and organic acids.

[Polyvalent Metal Salt]

The reaction liquid preferably contains a polyvalent metal salt as a reactant, in addition to the above-mentioned cationic resin having a structure of a quaternary ammonium salt. The polyvalent metal salt is dissociated and ionized into a polyvalent metal ion and an anion in the aqueous reaction liquid, and the polyvalent metal ion reacts with the aqueous ink. When the cationic resin and the polyvalent metal salt are used in combination, a further low molecular polyvalent metal ion quickly react with the anionic component in the ink to form an aggregate, and then the cationic resin having a structure of a quaternary ammonium salt further reacts with the aggregate. Accordingly, the time until the ink is thickened can be shortened, so that the effect of suppressing the image unevenness is increased.

Examples of the polyvalent metal ion may include: divalent metal ions, such as Ca²⁺, Cu²⁺, Ni²⁺, Mg²⁺, Sr²⁺, Ba²⁺and Zn²⁺; and trivalent metal ions, such as Fe³⁺, Cr³⁺, Y³⁺and Al³⁺. The polyvalent metal salt (which may be a hydrate) composed of the polyvalent metal ion and an anion binding to each other may be used to incorporate the polyvalent metal ion into the reaction liquid. That is, the polyvalent metal salt that produce the polyvalent metal ion in the reaction liquid can be added to the reaction liquid. In the polyvalent metal salt, examples of such anion may include: inorganic anions, such as Cl⁻, Br⁻, I⁻, ClO⁻, ClO₂⁻, ClO³; ClO₄⁻, NO₂⁻, NO₃⁻, SO₄²⁻; CO₃²⁻, HCO₃⁻, PO₄³⁻, HPO₄²⁻ and H₂PO₄⁻; and organic anions, such as HCOO⁻, (COO⁻)₂, COOH(COO⁻), CH₃COO⁻, CH₃CH(OH)COO⁻, C₂H₄(COO⁻)₂, C₆H₅COO⁻, C₆H₄(COO⁻)₂ and CH₃SO₃⁻. One or two or more polyvalent metal salts may be incorporated into the reaction liquid. Among polyvalent metal salts, magnesium sulfate is preferably used.

When the polyvalent metal salt is used as the reactant in addition to the above-mentioned cationic resin, its content (% by mass) in terms of polyvalent metal salt in the reaction liquid is preferably 0.05% by mass or more to 20.00% by mass or less with respect to the total mass of the reaction liquid. The above-mentioned content in terms of polyvalent metal salt is more preferably 1.00% by mass or more to 15.00% by mass or less. In this specification, when the polyvalent metal salt is a hydrate, the “content (% by mass) of the polyvalent metal salt” in the reaction liquid means the “content (% by mass) of the anhydride of the polyvalent metal salt” obtained by removing water serving as a hydrate.

[Organic Acid]

The reaction liquid containing the organic acid has a buffering capacity in an acidic region (at a pH of less than 7.0, preferably at a pH of from 2.0 to 5.0) to efficiently turn the anionic group of the components present in the ink into an acid type, to thereby aggregate the ink. Examples of the organic acid may include: monocarboxylic acids, such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid and coumalic acid, and salts thereof; dicarboxylic acids, such as oxalic acid, malonic acid, succinic acid, glutaric acid, adipic acid, maleic acid, fumaric acid, itaconic acid, sebacic acid, phthalic acid, malic acid and tartaric acid, and salts and hydrogen salts thereof; tricarboxylic acids, such as citric acid and trimellitic acid, and salts and hydrogen salts thereof; and tetracarboxylic acids such as pyromellitic acid, and salts and hydrogen salts thereof. When the organic acid is used as the reactant, the content (% by mass) of the organic acid in the reaction liquid is preferably 1.00% by mass or more to 50.00% by mass or less with respect to the total mass of the reaction liquid.

[Aqueous Medium]

The reaction liquid is an aqueous reaction liquid containing at least water as an aqueous medium. Examples of the aqueous medium to be used in the reaction liquid may include the same examples as those of an aqueous medium that can be incorporated into the ink to be described later. A water-soluble organic solvent to be described later that can be incorporated into the ink may be incorporated into the aqueous medium to be used in the reaction liquid. The content (% by mass) of the water in the reaction liquid is preferably 80.00% by mass or more to 99.50% by mass or less with respect to the total mass of the reaction liquid and more preferably 85.00% by mass or more to 99.00% by mass or less.

Examples of the water-soluble organic solvent that can be suitably incorporated into the reaction liquid include alkanediols such as 1,2-propanediol, 1,2-butanediol, 1,3-butanediol, 1,4-butanediol, 1,5-pentanediol and 1,6-hexanediol; amino acids such as β-alanine and trimethylglycine; sulfonyl compounds such as bis(2-hydroxyethyl)sulfone; alkylene glycols such as triethylene glycol, tetraethylene glycol, tripropylene glycol and polyethylene glycol having a number-average molecular weight of around 200 to 1,000; and sugars such as sorbitol. One or two or more water-soluble organic solvents may be incorporated into the reaction liquid.

The water-soluble organic solvents as mentioned above have a function of reducing the surface tension of a liquid immediately after the interface formation. Since the surface tension of the liquid obtained by replacing the surfactant in the reaction liquid with water at 25° C. is required to be 60 mN/m or more, the water-soluble organic solvent can be used within a range satisfying the requirement. The surface tension of the liquid obtained by replacing the surfactant in the reaction liquid with water is preferably 64 mN/m or more. The surface tension of the liquid obtained by replacing the surfactant in the reaction liquid with water is set to a value of the surface tension of a liquid in which the components in the reaction liquid excluding the surfactant are mixed and prepared. The surface tension of the liquid obtained by replacing the surfactant in the reaction liquid with water at 25° C. is preferably 74 mN/m or less. The surface tension of the liquid obtained by replacing the surfactant in the reaction liquid with water at 25° C. is the static surface tension measured by a platinum plate method.

When the composition of the reaction liquid is unclear, the aqueous medium contained in the reaction liquid is required to be quantitatively determined. Specifically, first, the amount of water and the water-soluble organic solvent contained in the reaction liquid is measured. 2 g of the reaction liquid is weighed on a petri dish, allowed to stand in an oven at 110° C. for 24 hours, and dried. The mass after drying is measured, and the solid content (1) is calculated from “mass after drying/mass before drying×100”. By calculating 100-(1), the amount of water and the water-soluble organic solvent contained in the reaction liquid (2) can be determined. Then, the water-soluble organic solvent in the reaction liquid is quantitatively determined. The reaction liquid is diluted with methanol or the like, and the water-soluble organic solvent contained in the reaction liquid is quantitatively determined by gas chromatography-mass spectrometry. The total amount of the water-soluble organic solvent is set to (3). The content of water in the reaction liquid can be determined from (2)-(3). The liquid obtained by replacing the surfactant in the reaction liquid with water is preferably prepared by mixing the water-soluble organic solvent and water from the composition quantitatively determined as mentioned above to prepare the aqueous medium excluding the surfactant, and then adding the components other than the aqueous medium, such as the cationic resin. By measuring the surface tension of the liquid, the surface tension immediately after the interface formation can be assessed.

The reaction liquid may not contain the water-soluble organic solvent, and the content (% by mass) of the water-soluble organic solvent in the reaction liquid is preferably 10.00% by mass or less with respect to the total mass of the reaction liquid. When the reaction liquid contains the water-soluble organic solvent, the content (% by mass) of the water-soluble organic solvent in the reaction liquid is more preferably 1.00% by mass or more to 10.00% by mass or less, still more preferably 1.00% by mass or more to 5.00% by mass or less.

(Surfactant)

The reaction liquid may contain various surfactants. The surfactant is a molecule having a hydrophobic moiety and a hydrophilic moiety, and significantly reduces the static surface tension of a liquid. Examples of the surfactant include hydrocarbon-based surfactants, fluorine-based surfactants, and silicone-based surfactants. One or two or more of these surfactants may be incorporated into the reaction liquid. These surfactants may be any of nonionic surfactants, anionic surfactants, cationic surfactants, and amphoteric surfactants. Specific examples of the surfactant include hydrocarbon-based surfactants such as an ethylene oxide adduct of acetylene glycol, polyethylene glycol alkyl ether and a polyoxyethylene polyoxypropylene block polymer; fluorine-based surfactants such as a perfluoroalkyl ethylene oxide adduct; and silicone-based surfactants such as a polyether modified siloxane compound. Of those, the reaction liquid preferably contains a hydrocarbon-based surfactant. The content (% by mass) of the surfactant in the reaction liquid is preferably 0.01% by mass or more to 5.00% by mass or less with respect to the total mass of the reaction liquid.

[Other Component]

The reaction liquid may contain various other components as required. Examples of the other components may include the same examples as those of other components that can be incorporated into the ink to be described later.

[Physical Properties of Reaction Liquid]

The reaction liquid is an aqueous reaction liquid to be applied to an ink jet system. Accordingly, from the viewpoint of reliability, it is preferred that the physical property values of the reaction liquid be appropriately controlled. Specifically, the surface tension of the reaction liquid at 25° C. is preferably 20 mN/m or more to 60 mN/m or less, more preferably 23 mN/m or more to 35 mN/m or less. When the surface tension of the reaction liquid at 25° C. is 23 mN/m or more, the reaction liquid is gently leveled after application to the recording medium. Accordingly, the permeation of the reaction liquid into the recording medium hardly progresses, the contact with the ink is increased, and the effect of suppressing the image unevenness is increased. Further, when the surface tension of the reaction liquid at 25° C. is 35 mN/m or less, the wettability between the ink and the reaction liquid is increased and the reaction efficiency is increased. Accordingly, the effect of suppressing the image unevenness is increased.

In addition, the viscosity of the reaction liquid at 25° C. is preferably 1.0 mPa·s or more to 10.0 mPa·s or less, more preferably 1.5 mPa·s or more to 2.7 mPa·s or less. When the viscosity of the reaction liquid at 25° C. is 1.5 mPa·s or more, the permeation of the reaction liquid into the recording medium is suppressed and the effect of suppressing the image unevenness is increased. Further, when the viscosity of the reaction liquid at 25° C. is 2.7 mPa·s or less, the reaction liquid easily spreads upon contact with the ink and aggregability is increased. Accordingly, the effect of suppressing the image unevenness is increased. The pH of the reaction liquid at 25° C. is preferably 5.0 or more to 9.5 or less, more preferably 6.0 or more to 9.0 or less.

<Ink>

The ink to be used in the recording method of the present invention is an aqueous ink for ink jet that contains the pigment as the coloring material. Respective components to be used in the ink and the like are described in detail below. The ink is not required to be hardened by an active energy ray such as an ultraviolet ray or an electron beam, and thus, may not contain such a monomer that is polymerized by irradiation with an active energy ray.

[Coloring Material]

The ink contains the pigment as the coloring material. The ink may further contain a dye as the coloring material. The ink may contain one or more of the coloring materials. The content (% by mass) of the coloring material in the ink is preferably 0.50% by mass or more to 15.00% by mass or less, more preferably 1.00% by mass or more to 10.00% by mass or less with respect to the total mass of the ink.

Specific examples of the pigment may include: inorganic pigments, such as carbon black and titanium oxide; and organic pigments, such as azo, phthalocyanine, quinacridone, isoindolinone, imidazolone, diketopyrrolopyrrole and dioxazine pigments. The pigments may be used alone or in combination thereof.

A resin-dispersed pigment using a resin as a dispersant, a self-dispersible pigment, which has a hydrophilic group bonded to its particle surface, or the like may be used as a dispersion system for the pigment. In addition, a resin-bonded pigment having a resin-containing organic group chemically bonded to its particle surface, a microcapsule pigment, which contains a particle whose surface is covered with, for example, a resin, or the like may be used. Pigments different from each other in dispersion system out of those pigments may be used in combination. Of those, not a resin-bonded pigment or a microcapsule pigment but a resin-dispersed pigment having a resin serving as a dispersant, the resin being caused to physically adsorb to its particle surface, is preferably used.

A dispersant that can disperse the pigment in an aqueous medium through the action of an anionic group is preferably used as a resin dispersant for dispersing the pigment in the aqueous medium. A resin having an anionic group may be used as the resin dispersant and such a resin as described later, in particular, a water-soluble resin is preferably used. The mass ratio of the content (% by mass) of the pigment in the ink to the content (% by mass) of the resin dispersant therein is preferably 0.3 times or more to 10.0 times or less.

A pigment having an anionic group bonded to its particle surface directly or through any other atomic group (—R—) may be used as the self-dispersible pigment. Specific examples of the other atomic group (—R—) may include: a linear or branched alkylene group having 1 to 12 carbon atoms; an arylene group, such as a phenylene group or a naphthylene group; a carbonyl group; an imino group; an amide group; a sulfonyl group; an ester group; and an ether group. In addition, groups obtained by combining those groups may be adopted.

A dye having an anionic group is preferably used as the dye. Specific examples of the dye may include dyes, such as azo, triphenylmethane, (aza)phthalocyanine, xanthene and anthrapyridone dyes.

Examples of the above-described anionic group mentioned in the description of the resin dispersant, the self-dispersible pigment and the dye include carboxylic acid groups, sulfonic acid groups and phosphonic acid groups. The anionic group may be any one of an acid type and a salt type. When the anionic group is a salt type, the group may be in any one of a state in which a part of the group dissociates or a state in which the entire group dissociates. When the anionic group is salt type, examples of cation serving as a counterion include an alkali metal cation, ammonium and organic ammonium. The coloring material to be incorporated into the ink is preferably a pigment, more preferably a resin-dispersed pigment or a self-dispersible pigment.

The amount (mmol/g) of the anionic group of the pigment can be measured by the above-mentioned colloid titration method. From the viewpoint of more easily suppressing the image unevenness, the ratio of the amount (mmol/g) of the cationic group in the above-mentioned reaction liquid to the amount (mmol/g) of the anionic group of the pigment in the ink is preferably 2.0 or more. The ratio of the amount of the cationic group in the reaction liquid to the amount of the anionic group of the pigment in the ink is more preferably 5.0 or more to 45.0 or less. The amount of the cationic group in the reaction liquid can be determined from the amount of the cationic group of the cationic resin in the reaction liquid. Alternatively, when the reaction liquid contains the polyvalent metal salt in addition to the cationic resin, the amount of the cationic group in the reaction liquid can be determined from the total amount of the amount of the cationic group of the cationic resin and the amount of the cationic group in the polyvalent metal salt. The amount of the cationic group in the polyvalent metal salt can also be measured by the above-mentioned colloid titration method.

[Resin]

A resin may be incorporated into the ink. The use of the ink including the resin can record an image improved in abrasion resistance. The resin may be added to the ink (i) for stabilizing the dispersed state of the pigment, that is, as a resin dispersant or an aid therefor. In addition, the resin may be added to the ink (ii) for improving the various characteristics of an image to be recorded.

The content (% by mass) of the resin in the ink is preferably 0.10% by mass or more to 20.00% by mass or less, more preferably 0.50% by mass or more to 15.00% by mass or less with respect to the total mass of the ink. Examples of the form of the resin may include a block copolymer, a random copolymer, a graft copolymer and a combination thereof. In addition, the resin may be a water-soluble resin that can be dissolved in an aqueous medium or may be a resin particle to be dispersed in the aqueous medium. The resins may be used alone or in combination thereof. [Composition of Resin]

Examples of the resin may include an acrylic resin, a urethane-based resin and an olefin-based resin. Of those, an acrylic resin and a urethane-based resin are preferred and an acrylic resin including a unit derived from (meth)acrylic acid or a (meth)acrylate is more preferred.

A resin having a hydrophilic unit and a hydrophobic unit as its structural units is preferred as the acrylic resin. Of those, a resin having a hydrophilic unit derived from (meth)acrylic acid and a hydrophobic unit derived from at least one of a monomer having an aromatic ring and a (meth)acrylic acid ester-based monomer is preferred. A resin having a hydrophilic unit derived from (meth)acrylic acid and a hydrophobic unit derived from at least one monomer of styrene and a-methylstyrene is particularly preferred. Those resins may each be suitably utilized as a resin dispersant for dispersing the pigment because the resins each easily cause an interaction with the pigment.

The hydrophilic unit is a unit having a hydrophilic group such as an anionic group. The hydrophilic unit may be formed by, for example, polymerizing a hydrophilic monomer having a hydrophilic group. Specific examples of the hydrophilic monomer having a hydrophilic group may include: acidic monomers each having a carboxylic acid group, such as (meth)acrylic acid, itaconic acid, maleic acid and fumaric acid; and anionic monomers, such as anhydrides and salts of these acidic monomers. A cation for forming the salt of the acidic monomer may be, for example, a lithium, sodium, potassium, ammonium or organic ammonium ion. The hydrophobic unit is a unit free of a hydrophilic group such as an anionic group. The hydrophobic unit may be formed by, for example, polymerizing the hydrophobic monomer free of a hydrophilic group such as anionic group. Specific examples of the hydrophobic monomer may include: monomers each having an aromatic ring, such as styrene, a-methylstyrene and benzyl (meth)acrylate; and (meth)acrylic acid ester-based monomers, such as methyl (meth)acrylate, butyl (meth)acrylate and 2-ethylhexyl (meth)acrylate.

The urethane-based resin may be obtained by, for example, causing a polyisocyanate and a polyol to react with each other. In addition, a chain extender may be further caused to react with the reaction product. Examples of the olefin-based resin may include polyethylene and polypropylene.

[Properties of Resin]

The phrase “resin is water-soluble” as used herein means that when the resin is neutralized with an alkali whose amount is equivalent to its acid value, the resin is present in an aqueous medium under a state in which the resin does not form any particle whose particle diameter may be measured by a dynamic light scattering method. Whether or not the resin is water-soluble can be judged in accordance with the following method. First, a liquid (resin solid content: 10% by mass) containing the resin neutralized with an alkali (e.g., sodium hydroxide or potassium hydroxide) corresponding to its acid value is prepared. Next, the prepared liquid is diluted with pure water tenfold (on a volume basis) to prepare a sample solution. Then, when no particle having a particle diameter is measured at the time of the measurement of the particle diameter of the resin in the sample solution by the dynamic light scattering method, the resin can be judged to be water-soluble. Measurement conditions at this time may be set, for example, as follows: SetZero: 30 seconds; number of times of measurement: 3; and measurement time: 180 seconds. In addition, a particle size analyzer based on the dynamic light scattering method (e.g., an analyzer available under the product name “UPA-EX150” from Nikkiso Co., Ltd.) or the like may be used as a particle size distribution measuring device. Of course, the particle size distribution measuring device to be used, the measurement conditions and the like are not limited to the foregoing.

The acid value of the water-soluble resin is preferably 100 mgKOH/g or more to 250 mgKOH/g or less. The weight-average molecular weight of the water-soluble resin is preferably 3,000 or more to 15,000 or less.

The acid value of a resin for forming the resin particle is preferably 5 mgKOH/g or more to 100 mgKOH/g or less. The weight-average molecular weight of the resin for forming the resin particle is preferably 1,000 or more to 3,000,000 or less, more preferably 100,000 or more to 3,000,000 or less. The volume-based 50% cumulative particle diameter (D₅₀) of the resin particle measured by a dynamic light scattering method is preferably 50 nm or more to 500 nm or less. The volume-based 50% cumulative particle diameter of the resin particle is the diameter of the particle in a particle diameter cumulative curve at which the ratio of the particle integrated from small particle diameters reaches 50% with respect to the total volume of the measured particle. The volume-based 50% cumulative particle diameter of the resin particle may be measured with the above-mentioned particle size analyzer of a dynamic light scattering system and under the above-mentioned measurement conditions. The glass transition temperature of the resin particle is preferably 40° C. or more to 120° C. or less, more preferably 50° C. or more to 100° C.or less. The glass transition temperature (C) of the resin particle may be measured with a differential scanning calorimeter (DSC). The resin particle does not need to include any coloring material.

[Wax Particle]

A particle formed of a wax (wax particle) may be incorporated into the ink. The use of the ink including the wax particle can record an image further improved in abrasion resistance. The wax in this specification may be a composition blended with a component except the wax or may be the wax itself. The wax particle may be dispersed with a dispersant, such as a surfactant or a resin. The waxes may be used alone or in combination thereof. The content (% by mass) of the wax particle in the ink is preferably 0.10% by mass or more to 10.00% by mass or less, more preferably 1.00% by mass or more to 5.00% by mass or less with respect to the total mass of the ink.

The wax is an ester of a higher monohydric or dihydric alcohol that is insoluble in water and a fatty acid in a narrow sense. Accordingly, animal-based waxes and plant-based waxes are included in the category of the wax but oils and fats are not included therein. High-melting point fats, mineral-based waxes, petroleum-based waxes and blends and modified products of various waxes are included therein in a broad sense. In the present invention, the waxes in a broad sense may each be used without any particular limitation. The waxes in a broad sense may be classified into natural waxes, synthetic waxes, blends thereof (blended waxes) and modified products thereof (modified waxes).

Examples of the natural wax may include: animal-based waxes, such as beeswax, a spermaceti wax and lanolin; plant-based waxes, such as a Japan wax, a carnauba wax, a sugar cane wax, a palm wax, a candelilla wax and a rice wax; mineral-based waxes such as a montan wax; and petroleum-based waxes, such as a paraffin wax, a microcrystalline wax and petrolatum. Examples of the synthetic wax may include hydrocarbon-based waxes, such as a Fischer-Tropsch wax and polyolefin waxes (e.g., polyethylene wax and polypropylene wax). The blended waxes are mixtures of the above-mentioned various waxes. The modified waxes are obtained by subjecting the above-mentioned various waxes to modification treatment, such as oxidation, hydrogenation, alcohol modification, acrylic modification or urethane modification. The above-mentioned waxes may be used alone or in combination thereof. The wax is preferably at least one kind selected from the group consisting of: a microcrystalline wax; a Fischer-Tropsch wax; a polyolefin wax; a paraffin wax; and modified products and blends thereof. Of those, a blend of a plurality of kinds of waxes is more preferred and a blend of a petroleum-based wax and a synthetic wax is particularly preferred.

The wax is preferably a solid at normal temperature (25° C.). The melting point (° C.) of the wax is preferably 40° C. or more to 120° C. or less, more preferably 50° C. or more to 100° C. or less. The melting point of the wax may be measured in conformity with a test method described in the section 5.3.1 (Melting Point Testing Method) of JIS K 2235: 1991 (Petroleum Waxes). In the cases of a microcrystalline wax, petrolatum and a mixture of a plurality of kinds of waxes, their melting points may be measured with higher accuracy by utilizing a test method described in the section 5.3.2 thereof. The melting point of the wax is susceptible to characteristics, such as a molecular weight (a larger molecular weight provides a higher melting point), a molecular structure (a linear structure provides a higher melting point but a branched structure provides a lower melting point), crystallinity (higher crystallinity provides a higher melting point) and a density (a higher density provides a higher melting point). Accordingly, the control of those characteristics can provide a wax having a desired melting point. The melting point of the wax in the ink may be measured, for example, as follows: after the wax fractionated by subjecting the ink to ultracentrifugation treatment has been washed and dried, its melting point is measured in conformity with each of the above-mentioned test methods.

[Aqueous Medium]

The ink to be used in the recording method of the present invention is an aqueous ink including at least water as an aqueous medium. An aqueous medium that is the water or a mixed solvent of the water and a water-soluble organic solvent may be incorporated into the ink. Deionized water or ion-exchanged water is preferably used as the water. The content (% by mass) of the water in the aqueous ink is preferably 50.00% by mass or more to 95.00% by mass or less with respect to the total mass of the ink. In addition, the content (% by mass) of the water-soluble organic solvent in the aqueous ink is preferably 2.00% by mass or more to 40.00% by mass or less with respect to the total mass of the ink. Solvents that may be used in an ink for ink jet, such as alcohols, (poly)alkylene glycols, glycol ethers, nitrogen-containing solvents and sulfur-containing solvents, may each be used as the water-soluble organic solvent. The water-soluble organic solvents may be used alone or in combination thereof.

[Water-soluble Hydrocarbon Compound]

The water-soluble organic solvent to be incorporated into the ink preferably contains a specific water-soluble hydrocarbon compound. The water-soluble hydrocarbon compound is a compound having a hydrocarbon chain having 3 or more carbon atoms, the compound being substituted with 2 or more hydrophilic groups each selected from the group consisting of: a hydroxy group; an amino group; and an anionic group. However, the hydrocarbon chain may be interrupted by a sulfonyl group or an ether group. When the number of the carbon atoms of the hydrocarbon chain is 3 or 4, the hydrophilic groups include an anionic group or the hydrocarbon chain is interrupted by a sulfonyl group.

In the present invention, a hydrocarbon compound in the state of being dissolved in water at a content of the compound in the ink at 25° C. is defined as being “water-soluble”. That is, the solubility of the compound in water at 25° C. is larger than the content thereof in the ink. The fact that the hydrocarbon chain is interrupted by a sulfonyl group or an ether group means that a sulfonyl group (—S(═O)₂—) or an ether group (—O—) is present in the middle of the hydrocarbon chain. The water-soluble hydrocarbon compound has hydrogen-bonding groups, such as a hydroxy group, an amino group, an anionic group, a sulfonyl group and an ether group. Accordingly, the use of the ink including the hydrocarbon compound can suppress the cockling or curl of a recording medium having recorded thereon an image. A general hydrocarbon compound having a hydrocarbon chain having a relatively small number of carbon atoms (3 or 4 carbon atoms) tends to have a small molecular weight and hence have a low vapor pressure. However, the above-mentioned water-soluble hydrocarbon compound has a hydrogen-bonding anionic group or its hydrocarbon chain is interrupted by a sulfonyl group.

Accordingly, the compound hardly evaporates owing to an intermolecular or intramolecular interaction and hence remains between fibers for forming the recording medium to exhibit a suppressing action on the cockling or the curl. The content (% by mass) of the water-soluble hydrocarbon compound in the ink is preferably 1.00% by mass or more to 20.00% by mass or less with respect to the total mass of the ink.

The number of the carbon atoms of the hydrocarbon chain for forming the water-soluble hydrocarbon compound is preferably 3 or more to 50 or less, more preferably 3 or more to 10 or less. Examples of the anionic group may include a sulfonic acid group and a carboxylic acid group. Specific examples of the water-soluble hydrocarbon compound may include: alkanediols, such as 1,5-pentanediol and 1,6-hexanediol; amino acids, such as alanine, ß-alanine, trimethylglycine, amidosulfuric acid (alias: sulfamic acid), aminomethanesulfonic acid, taurine (alias: 2-aminoethanesulfonic acid), carbamic acid, glycine, aspartic acid, glutamic acid, sulfanilic acid or salts of any of the acids described above, phenylalanine, leucine, isoleucine, threonine, tryptophan, valine, methionine, lysine and arginine; sulfonyl compounds such as bis(2-hydroxyethyl)sulfone; alkylene glycols, such as triethylene glycol, tetraethylene glycol, tripropylene glycol and a polyethylene glycol having a number-average molecular weight of from about 200 to about 1,000; and sugars, such as sorbitol, D-sorbitol, xylitol, trehalose, fructose and D(+)-xylose. The water-soluble hydrocarbon compounds may be used alone or in combination thereof.

[Other Component]

The ink may include various other components as required. Examples of other components may include various additives, such as an antifoaming agent, a surfactant, a pHadjustor, a viscosity modifier, a rust inhibitor, an antiseptic, a fungicide, an antioxidant and an anti-reducing agent. However, the ink is preferably free of the reactant to be incorporated into the reaction liquid.

[Physical Properties of Ink]

The ink is an aqueous ink to be applied to an ink jet system. Accordingly, from the viewpoint of reliability, it is preferred that the physical property values of the ink be appropriately controlled. Specifically, the surface tension of the ink at 25° C. is preferably 20 mN/m or more to 60 mN/m or less and more preferably20 mN/m or more to 40 mN/m or less. In addition, the viscosity of the ink at 25° C. is preferably 1.0 mPads or more to 10.0 mPa's or less and more preferably 1.0 mPa's or more to 7.0 mPa's or less. The pH of the ink at 25° C. is preferably 7.0 or more to 9.5 or less, more preferably 8.0 or more to 9.5 or less.

In addition, in the ink jet recording method using the reaction liquid and the ink, the reaction liquid and the ink are mixed on the recording medium and thereby thickened, so that an image is recorded. Thus, the viscosity of the mixture influences the image. It is preferable that the mass ratio (the amount of the reaction liquid applied/the amount of the ink applied) of the amount of the reaction liquid applied to the amount of the ink applied to the recording medium be in the range of 0.05 or more to 0.80 or less, and the viscosity of the mixture of the ink and the reaction liquid is 10 times or more to 100 times or less with respect to the viscosity of the ink. When the viscosity of the mixture of the ink and the reaction liquid is 10 times or more with respect to the viscosity of the ink, the effect of suppressing the image unevenness is further increased. In addition, when the viscosity of the mixture of the ink and the reaction liquid is 100 times or less with respect to the viscosity of the ink, the reactant is not too much, deposition on the image does not occur, the effect of suppressing the image unevenness is not impaired, and a good image can be obtained. The viscosity of the mixture of the ink and the reaction liquid can be measured with a rotational viscometer at 25° C.

### Examples

The present invention is described in more detail below by way of Examples and Comparative Examples. The present invention is by no means limited to Examples below without departing from the gist of the present invention. “Part(s)” and “%” with regard to the description of the amounts of components are by mass unless otherwise stated.

<Preparation of Reaction Liquid>

Cationic resins 1 to 7 illustrated in Table 1 were prepared. The charge density (meq/g) of the cationic resin was measured by the above-mentioned colloid titration method.

The weight average molecular weight of the cationic resin was measured under the following conditions using gel permeation chromatography (trade name “Waters ALLIANCE e2695”, manufactured by Waters Corporation) in terms of polystyrene.

Column: trade name “Asahipak GF-310 HQ” and “Asahipak GF-510 HQ” (both manufactured by Showa Denko K.K.)

Eluent: 0.5 mol/L acetic acid 0.1 mol/L sodium nitrate

Feeding speed: 1.0 mL/min

Oven temperature: 40° C.

Detector: differential refractometer (RI) detector (trade name “Wyatt Optilab rex refractive index detector”, manufactured by Wyatt Technology Corporation)

In the calculation of the weight average molecular weight, a molecular weight calibration curve produced by using a molecular weight standard (trade name “EasiCal Type PS-2 polystyrene”, manufactured by Agilent Technologies, Inc.) was utilized.

TABLE 1
Aqueous solution of the cationic resin

| | | | | | Weight | |
|---|---|---|---|---|---|---|
| | | | | | average | Charge |
| Cationic | | | Type of | Concentration | molecular | density |
| resin | Product name | Component | amine | (%) | weight | (meq/g) |
| 1 | PAS-H-1L | Diallyldimethyl-ammoniumchloride | Quaternary | 28 | 8,500 | 6.2 |
| | (manufactured by | polymer | | | | |
| | NITTOBO MEDICAL | | | | | |
| | CO., LTD.) | | | | | |
| 2 | PAS-2401 | Diallylmethylethyl- | Quaternary | 25 | 2,000 | 2.0 |
| | (manufactured by | ammoniumethylsulfate sulfur | | | | |
| | NITTOBO MEDICAL | dioxide copolymer | | | | |
| | CO., LTD.) | | | | | |
| 3 | PQ40U05NV | Diallyldimethyl-ammoniumchloride | Quaternary | 40 | 4,000 | 6.2 |
| | (manufactured by | polymer | | | | |
| | KAT POL) | | | | | |
| 4 | PAS-H-5L | Diallyldimethyl-ammoniumchloride | Quaternary | 28 | 30,000 | 6.2 |
| | (manufactured by | polymer | | | | |
| | NITTOBO MEDICAL | | | | | |
| | CO.,LTD.) | | | | | |
| 5 | Catiomaster PD-30 | Poly-2-hydroxypropyl | Quaternary | 50 | 9,000 | 5.8 |
| | (manufactured by | dimethylammonium chloride | | | | |
| | Yokkaichi Chemical | | | | | |
| | Co., Ltd.) | | | | | |
| 6 | PAA-HCL-3L | Polyallylamine | Primary | 50 | 15,000 | 16.0 |
| | (manufactured by | | | | | |
| | NITTOBO MEDICAL | | | | | |
| | CO., LTD.) | | | | | |
| 7 | EPOMINSP-200 | Polyethyleneimine | Primary, | 98 | 10,000 | 18.0 |
| | (manufactured by | | Secondary | | | |
| | NIPPON SHOKUBAI | | and | | | |
| | CO., LTD.) | | Tertiary | | | |

Each component (unit: %) illustrated in the upper column in Tables 2-1 to 2-3 was mixed, sufficiently stirred, and then filtered through a cellulose acetate filter having a pore size of 3.0 μm (manufactured by ADVANTEC CO., LTD.) under pressure to prepare each reaction liquid. “Acetylenol E100” illustrated in Tables 2-1 to 2-3 is the trade name of a surfactant manufactured by Kawaken Fine Chemicals Co., Ltd. (the same applies to Table 3 below). “BYK-348” is the trade name of a surfactant manufactured by BYK-Chemie Japan KK. “Proxel GXL(S)” is the trade name of an antiseptic manufactured by LONZA KK. (the same applies to Table 3 below). In the lower column in Tables 2-1 to 2-3, the surface tension (mN/m) of the liquid obtained by replacing the surfactant in the reaction liquid with water at 25° C., the surface tension (mN/m) of the reaction liquid, the viscosity (mPa·s) and the amount R (mmol/g) of the cationic group were illustrated as the characteristics of the reaction liquid. The amount (mmol/g) of the cationic group in the reaction liquid was measured as follows. The amount of the cationic group R (mmol/g) was determined from the charge amount (meq/g) of each of the polyvalent metal salt (magnesium sulfate) and the cationic resin measured by the above-mentioned colloid titration method, based on the content (%) of these components.

For the surface tension of the liquid obtained by replacing the surfactant in the reaction liquid with water at 25° C., the surface tension of the sample prepared by mixing and stirring the components illustrated in Tables 2-1 to 2-3 excluding the surfactants (Acetylenol E100 and BYK-348) was measured. For the surface tension of the reaction liquid, the surface tension of the sample prepared by mixing and stirring all components illustrated in Tables 2-1 to 2-3 was measured. The surface tension is a value measured by a platinum plate method using an automatic surface tension meter (DY-300 type, manufactured by Kyowa Interface Science Co., Ltd.). The viscosity of the reaction liquid was measured using an E-type viscometer (trade name “RE-85L”, manufactured by Toki Sangyo Co., Ltd) under the conditions of a temperature of 25° C. and 50 rpm.

TABLE 2-1
Composition and property of the reaction liquids

| | Reaction liquid | | | | | | | | | |
|---|---|---|---|---|---|---|---|---|---|---|
| | 1 | 2 | 3 | 4 | 5 | 6 | 7 | 8 | 9 | 10 |
| Cationic resin 1 | 3.57 | 3.57 | 3.57 | 3.57 | | | | | 4.28 | 3.57 |
| Cationic resin 2 | | | | | 4.00 | | | | | |
| Cationic resin 3 | | | | | | 2.50 | | | | |
| Cationic resin 4 | | | | | | | 1.00 | | | |
| Cationic resin 5 | | | | | | | | 2.00 | | |
| Cationic resin 6 | | | | | | | | | | |
| Cationic resin 7 | | | | | | | | | | |
| Magnesium sulfate | 7.00 | 7.00 | 7.00 | 7.00 | 7.00 | 7.00 | 7.00 | 7.00 | | |
| Magnesium chloride | | | | | | | | | | 5.50 |
| Calcium chloride | | | | | | | | | | |
| Calcium nitrate | | | | | | | | | | |
| 1,2-Propanediol | 6.00 | 10.00 | 7.00 | | 6.00 | 6.00 | 6.00 | 6.00 | 6.00 | 6.00 |
| 1,2-Hexanediol | | | | | | | | | | |
| Glycerin | | | | | | | | | | |
| 1,5-Pentanediol | | | | | | | | | | |
| Trimethylolpropane | | | | | | | | | | |
| Acetylenol E100 | 0.50 | 0.50 | 0.50 | 0.50 | 0.50 | 0.50 | 0.50 | 0.50 | 0.50 | 0.50 |
| BYK-348 | | | | | | | | | | |
| NIKKOL BC-20 | | | | | | | | | | |
| Proxel GXL(S) | 0.02 | 0.02 | 0.02 | 0.02 | 0.02 | 0.02 | 0.02 | 0.02 | 0.02 | 0.02 |
| lon-exchanged water | 82.91 | 78.91 | 81.91 | 88.91 | 82.48 | 83.98 | 85.48 | 84.48 | 89.20 | 84.41 |
| Surface tension of the liquid | 64 | 60 | 63 | 72 | 64 | 64 | 64 | 64 | 64 | 64 |
| obtained by replacing the | | | | | | | | | | |
| surfactant in the reaction liquid | | | | | | | | | | |
| (mN/m) | | | | | | | | | | |
| Surface tension of the reaction | 29 | 29 | 29 | 29 | 29 | 29 | 29 | 29 | 29 | 29 |
| liquid (mN/m) | | | | | | | | | | |
| Viscosity (mPa · s) | 2.2 | 2.7 | 2.7 | 1.5 | 2.2 | 2.2 | 1.5 | 2.2 | 1.9 | 2.2 |
| Amount of cationic groups R | 64.4 | 64.4 | 64.4 | 64.4 | 60.2 | 64.4 | 58.2 | 64.0 | 7.4 | 64.0 |
| (mmol/g) | | | | | | | | | | |

TABLE 2-2
Composition and property of the reaction liquids

| | Reaction liquid | | | | | | | | | |
|---|---|---|---|---|---|---|---|---|---|---|
| | 11 | 12 | 13 | 14 | 15 | 16 | 17 | 18 | 19 | 20 |
| Cationic resin 1 | 3.57 | 3.57 | 3.57 | 3.57 | 3.57 | 3.57 | 0.71 | 1.07 | 5.71 | 7.14 |
| Cationic resin 2 | | | | | | | | | | |
| Cationic resin 3 | | | | | | | | | | |
| Cationic resin 4 | | | | | | | | | | |
| Cationic resin 5 | | | | | | | | | | |
| Cationic resin 6 | | | | | | | | | | |
| Cationic resin 7 | | | | | | | | | | |
| Magnesium sulfate | | | 7.00 | 7.00 | 7.00 | 7.00 | 7.00 | 7.00 | 15.00 | 15.00 |
| Magnesium chloride | | | | | | | | | | |
| Calcium chloride | 6.40 | | | | | | | | | |
| Calcium nitrate | | 9.50 | | | | | | | | |
| 1,2-Propanediol | 6.00 | 6.00 | 6.00 | 6.00 | 6.00 | 6.00 | 3.00 | 3.50 | 6.00 | 6.00 |
| 1,2-Hexanediol | | | | | | | | | | |
| Glycerin | | | | | | | | | | |
| 1,5-Pentanediol | | | | | | | | | | |
| Trimethylolpropane | | | | | | | | | | |
| Acetylenol E100 | 0.50 | 0.50 | 0.50 | 0.50 | 0.15 | 0.16 | 0.50 | 0.50 | 0.50 | 0.50 |
| BYK-348 | | | 0.40 | 0.20 | | | | | | |
| NIKKOL BC-20 | | | | | | | | | | |
| Proxel GXL(S) | 0.02 | 0.02 | 0.02 | 0.02 | 0.02 | 0.02 | 0.02 | 0.02 | 0.02 | 0.02 |
| lon-exchanged water | 83.51 | 80.41 | 82.51 | 82.71 | 83.26 | 83.25 | 88.77 | 87.91 | 72.77 | 71.34 |
| Surface tension of the liquid | 64 | 64 | 64 | 64 | 64 | 64 | 69 | 68 | 64 | 64 |
| obtained by replacing the | | | | | | | | | | |
| surfactant in the reaction liquid | | | | | | | | | | |
| (mN/m) | | | | | | | | | | |
| Surface tension of the reaction | 29 | 29 | 22 | 23 | 35 | 36 | 29 | 29 | 29 | 29 |
| liquid (mN/m) | | | | | | | | | | |
| Viscosity (mPa · s) | 2.2 | 2.2 | 2.2 | 2.2 | 2.2 | 2.2 | 1.4 | 1.5 | 2.7 | 2.8 |
| Amount of cationic groups R | 63.9 | 64.1 | 64.4 | 64.4 | 64.4 | 64.4 | 59.4 | 60.0 | 134.5 | 137.0 |
| (mmol/g) | | | | | | | | | | |

TABLE 2-3
Composition and property of the reaction liquids

| | Reaction liquid | | | | | | | | | |
|---|---|---|---|---|---|---|---|---|---|---|
| | 21 | 22 | 23 | 24 | 25 | 26 | 27 | 28 | 29 | 30 |
| Cationic resin 1 | 1.43 | 3.50 | 11.20 | 1.43 | 3.57 | | | | 3.57 | |
| Cationic resin 2 | | | | | | | | | | |
| Cationic resin 3 | | | | | | | | | | |
| Cationic resin 4 | | | | | | | | | | |
| Cationic resin 5 | | | | | | | | | | |
| Cationic resin 6 | | | | | | 2.00 | | | | |
| Cationic resin 7 | | | | | | | 1.00 | | | |
| Magnesium sulfate | 0.05 | 0.05 | 15.00 | 0.05 | 7.00 | 7.00 | 7.00 | 7.00 | 7.00 | |
| Magnesium chloride | | | | | | | | | | |
| Calcium chloride | | | | | | | | | | |
| Calcium nitrate | | | | | | | | | | 5.00 |
| 1,2-Propanediol | 6.00 | 6.00 | 1.00 | 6.00 | 11.00 | 6.00 | 6.00 | 6.00 | | |
| 1,2-Hexanediol | | | | | | | | | 4.00 | |
| Glycerin | | | | | | | | | | 5.00 |
| 1,5-Pentanediol | | | | | | | | | | 5.00 |
| Trimethylolpropane | | | | | | | | | | 7.00 |
| Acetylenol E100 | 0.50 | 0.50 | 0.50 | 0.15 | 0.50 | 0.50 | 0.50 | 0.50 | 0.50 | |
| BYK-348 | | | | | | | | | | |
| NIKKOL BC-20 | | | | | | | | | | 1.00 |
| Proxel GXL(S) | 0.02 | 0.02 | 0.02 | 0.02 | 0.02 | 0.02 | 0.02 | 0.02 | 0.02 | |
| lon-exchanged water | 92.00 | 89.93 | 72.28 | 92.35 | 77.91 | 84.48 | 85.48 | 86.48 | 84.91 | 77.00 |
| Surface tension of the liquid | 64 | 64 | 69 | 64 | 59 | 64 | 64 | 64 | 31 | 54 |
| obtained by replacing the | | | | | | | | | | |
| surfactant in the reaction liquid | | | | | | | | | | |
| (mN/m) | | | | | | | | | | |
| Surface tension of the reaction | 29 | 29 | 29 | 36 | 29 | 29 | 29 | 29 | 28 | 59 |
| liquid (mN/m) | | | | | | | | | | |
| Viscosity (mPa · s) | 1.8 | 2.2 | 2.0 | 1.8 | 2.8 | 2.2 | 2.2 | 2.2 | 1.7 | 2.6 |
| Amount of cationic groups R | 2.9 | 6.5 | 144.1 | 2.9 | 64.4 | 74.2 | 75.8 | 58.2 | 64.4 | 30.5 |
| (mmol/g) | | | | | | | | | | |

<Preparation of Pigment Dispersion Liquid>

(Pigment Dispersion Liquid 1)

A styrene-ethyl acrylate-acrylic acid copolymer (resin 1) having an acid value of 150 mgKOH/g and a weight average molecular weight of 8,000 was prepared. 20.0 parts of the resin 1 was neutralized with potassium hydroxide equimolar to the acid value of the resin 1, and then an appropriate amount of pure water was added, whereby an aqueous solution of the resin 1 having a content of the resin (solid content) of 20.00% was prepared. 15.0 parts of a pigment (C.I. Pigment Blue 15:3), 22.5 parts of the aqueous solution of the resin 1 and 62.5 parts of pure water were mixed to obtain a mixture. The obtained mixture and 200 parts of zirconia beads having a diameter of 0.3 mm were put in a batch type vertical sand mill (manufactured by IMEX Co., Ltd.) and dispersed for 5 hours while cooling with water. After a coarse particle was removed by centrifugation, the mixture was filtered through a cellulose acetate filter having a pore size of 3.0 μm (manufactured by ADVANTEC CO., LTD.) under pressure to prepare a pigment dispersion liquid 1 having a content of the pigment of 15.00% and a content of the resin dispersant (resin 1) of 4.50%. The amount of the anionic group of the pigment in the pigment dispersion liquid 1 was measured by the above-mentioned colloid titration method, resulting in 0.80 mmol/g.

(Pigment Dispersion Liquid 2)

To a solution obtained by dissolving 5.0 g of concentrated hydrochloric acid in 5.5 g of water, 1.6 g of 4-amino-1,2-benzenedicarboxylic acid was added in a state cooled to 5° C. Then, a container filled with the solution was put in an ice bath to maintain the solution always at 10° C. or less, and a solution obtained by dissolving 1.8 g of sodium nitrite in 9.0 g of water at 5° C. was added thereto. After the solution was further stirred for 15 minutes, 6.0 g of C.I. Pigment Blue 15:3 was added thereto under stirring. Thereafter, the mixture was further stirred for 15 minutes, the obtained slurry was filtered through a filter (trade name: standard filter paper No. 2; manufactured by Advantec Co., Ltd.), and then the particle was thoroughly washed with water. The particle was dried in an oven at 110° ° C.to prepare a self-dispersible pigment. Further, water was added to the obtained self-dispersible pigment, the pigment was dispersed so that the content of the pigment was 15.00%, whereby a dispersion liquid was prepared. By the above-mentioned method, a pigment dispersion liquid in a state where the self-dispersible pigment in which a —C₆H₃—(COONa)₂ group was introduced on the pigment particle surface was dispersed in water was obtained. Thereafter, by replacing the sodium ion in the pigment dispersion liquid with the potassium ion using the ion exchange method, a pigment dispersion liquid 2 having dispersed self-dispersible pigment in which a benzenedicarboxylic acid group having a potassium counterion was bonded on the surface of the pigment was obtained. The amount of the anionic group of the self-dispersible pigment was measured by the above-mentioned colloid titration method, resulting in 0.40 mmol/g. The content of the pigment in the pigment dispersion liquid 2 prepared above was 15.00%, and the average particle size of the pigment was 120 nm.

(Pigment Dispersion Liquid 3)

A pigment dispersion liquid 3 having a pigment content of 15.00% and a resin dispersant (Resin 1) content of 4.50% was prepared by the same procedure as that of the above-mentioned pigment dispersion liquid 1 except that the pigment was changed to C.I. Pigment Red 122. The amount of the anionic group of the pigment in the pigment dispersion liquid 3 was measured by the above-mentioned colloid titration method, resulting in 0.80 mmol/g.

(Pigment Dispersion Liquid 4)

A pigment dispersion liquid 4 having a pigment content of 15.00% and a resin dispersant (Resin 1) content of 4.50% was prepared by the same procedure as that of the above-mentioned pigment dispersion liquid 1 except that the pigment was changed to carbon black. The amount of the anionic group of the pigment in the pigment dispersion liquid 4 was measured by the above-mentioned colloid titration method, resulting in 0.80 mmol/g.

(Pigment Dispersion Liquid 5)

A pigment dispersion liquid 5 having a pigment content of 15.00% and a resin dispersant (Resin 1) content of 4.50% was prepared by the same procedure as that of the above-mentioned pigment dispersion liquid 1 except that the pigment was changed to C.I.

Pigment Yellow 74. The amount of the anionic group of the pigment in the pigment dispersion liquid 5 was measured by the above-mentioned colloid titration method, resulting in 0.80 mmol/g.

<Preparation of Resin Particle>

(Resin Particle 1)

Into a four-necked flask equipped with a stirrer, a reflux cooling apparatus and a nitrogen gas introduction pipe, 59.5 parts of the ion-exchanged water and 0.2 parts of potassium persulfate were put and mixed. In addition, 20.0 parts of 2-ethylhexyl methacrylate, 20.0 parts of methacrylic acid and 0.3 parts of a reactive surfactant (trade name “ADEKA REASOAP ER-20”, manufactured by ADEKA CORPORATION) were mixed to prepare an emulsified product. Under nitrogen atmosphere, the prepared emulsified product was added dropwise into the above-mentioned four-necked flask for 1 hour, and the polymerization reaction was carried out for 2 hours while stirring at 80° C. After the mixture was cooled to 25° C., the ion-exchanged water and an aqueous solution containing potassium hydroxide equimolar to the acid value of the resin particle were added, whereby a water dispersion liquid of the resin particle 1 having a content of the resin particle (solid content) of 40.00% and a glass transition temperature of 72° C. was prepared.

<Preparation of Ink>

Each component (unit: %) illustrated in the upper column in Table 3 was mixed, sufficiently stirred, and then filtered under pressure with a cellulose acetate filter (manufactured by ADVANTEC CO., LTD.) having a pore size of 3.0 μm to prepare each ink. In the lower column in Table 3, the surface tension (mN/m) of the ink at 25° C. and the amount I (mmol/g) of the anionic group of the pigment in the ink were illustrated as the characteristics of the ink. As the surface tension of the ink, the surface tension of the sample prepared by mixing and stirring all components illustrated in the upper column in Table 3 was measured. The surface tension indicates a value measured by a platinum plate method using an automatic surface tension meter (DY-300 type, manufactured by Kyowa Interface Science Co., Ltd.).

TABLE 3
Composition and property of the inks

| | Ink | | | | | |
|---|---|---|---|---|---|---|
| | 1 | 2 | 3 | 4 | 5 | 6 |
| Pigment dispersion liquid 1 | 26.70 | | | | | 26.70 |
| Pigment dispersion liquid 2 | | 26.70 | | | | |
| Pigment dispersion liquid 3 | | | 26.70 | | | |
| Pigment dispersion liquid 4 | | | | 26.70 | | |
| Pigment dispersion liquid 5 | | | | | 26.70 | |
| 1,2-Butanediol | 15.00 | 15.00 | 15.00 | 15.00 | 15.00 | 15.00 |
| 1,4-Butanediol | | | | | | |
| Diethylene glycol | | | | | | |
| Water dispersion liquid of Resin particle 1 | 15.00 | 15.00 | 15.00 | 15.00 | 15.00 | |
| Water dispersion liquid of Resin particle 2 | | | | | | |
| Water dispersion liquid of Resin particle 3 | | | | | | |
| Acetylenol E100 | 1.00 | 1.00 | 1.00 | 1.00 | 1.00 | 1.00 |
| Proxel GXL(S) | 0.02 | 0.02 | 0.02 | 0.02 | 0.02 | 0.02 |
| lon-exchanged water | 42.28 | 42.28 | 42.28 | 42.28 | 42.28 | 57.28 |
| Surface tension of ink (mN/m) | 33 | 36 | 33 | 33 | 33 | 33 |
| Amount I of anionic group of pigment in | 3.2 | 1.6 | 3.2 | 3.2 | 3.2 | 3.2 |
| ink(mmol/g) | | | | | | |

<Recording Medium>

The recording medium illustrated in Table 4 were prepared. The water absorption amount indicates the water absorption amount from the start of contact to 30 msec^{1/2} in the Bristow method.

TABLE 4
Composition and property of the inks

| | Water | |
|---|---|---|
| | absorption | |
| Recording | amount | |
| Medium | (mL/m²) | Type |
| 1 | 9.5 | Low absorbent recording medium (Art paper, |
| | | Product name “Art PW8K”, manufactured |
| | | by LINTEC Corporation) |
| 2 | 4.5 | Low absorbent recording medium (Art paper, |
| | | Product name “Art K PZ2 8K”, manufactured |
| | | by LINTEC Corporation) |
| 3 | less | Non-absorbent recording medium (Plastic film, |
| | than 2.5 | Product name “PET WH50 PAT 8LK”, |
| | | manufactured by LINTEC Corporation) |
| 4 | 3.2 | Non-absorbent recording medium (Plastic film, |
| | | Product name “Yupo 80(UV)PW8E”, |
| | | manufactured by LINTEC Corporation) |
| 5 | 12.0 | Absorbent recording medium (Plain paper, |
| | | Product name“55 PW 8K COC”, manufactured |
| | | by LINTEC Corporation) |
| 6 | 18.0 | Absorbent recording medium (Plain paper, |
| | | Product name“Art E PW 8K BLUE”, |
| | | manufactured by LINTEC Corporation) |

<Evaluation>

The recording conditions are illustrated in Table 5, and the evaluation conditions are illustrated in the left column in Tables 6-1 and 6-2. The reaction liquid and the ink of types illustrated in the left column in Tables 6-1 and 6-2 were combined to form a set of the ink and the reaction liquid. In Tables 6-1 and 6-2, “R/I value (times)” is a ratio of the amount R (mmol/g) of the cationic group in the reaction liquid to the amount I (mmol/g) of the anionic group of the pigment in the ink. The reaction liquid and the ink constituting the set were respectively charged in the reaction liquid applying device 1201 and the ink applying device 1202 of the ink jet recording apparatus 1 having a configuration illustrated in FIG. 1. Using the ink jet recording apparatus 1, an image was recorded under the conditions illustrated in Table 5 and the left column in Tables 6-1 and 6-2. Specifically, after the reaction liquid (recording duty 30%) and the ink (recording duty 100%) were applied to the recording medium in the order presented, warm air at 60° C. was applied from the heating device 2100 to the recording medium to dry the image, whereby a solid image of 15 cm x 15 cm was recorded. In the ink jet recording apparatus 1 used in the present example, an image recorded under the conditions where one droplet of 4.0 ng of ink droplet is applied to a unit region of 1/1200 inches×1/1200 inches is defined as the recording duty of 100%. The “application time difference (msec)” illustrated in Table 5 is the time from the application of the reaction liquid to the recording medium to the application of the ink to the recording medium. In the present example, “AAA”, “AA”, “A” and “B” were determined as the acceptable level, and “C” was determined as the unacceptable level based on the following evaluation criteria. The evaluation results are illustrated in the right column in Tables 6-1 and 6-2.

TABLE 5
Recording condition

| | | Method for | Application | | Warm air |
|---|---|---|---|---|---|
| | Number of | applying | time | | drying |
| Recording | recording | reaction | difference | Drying | speed |
| condition | passes | liquid | (msec) | Step | (m/sec) |
| 1 | 1pass | Ejection | 900 | Yes | 30 |
| 2 | 1pass | Ejection | 100 | Yes | 30 |
| 3 | 1pass | Ejection | 1100 | Yes | 30 |
| 4 | 1pass | Ejection | 1200 | Yes | 30 |
| 5 | 1pass | Ejection | 900 | None | — |
| 6 | 1pass | Ejection | 900 | Yes | 10 |
| 7 | 1pass | Ejection | 900 | Yes | 40 |
| 8 | 1pass | Ejection | 900 | Yes | 45 |
| 9 | 1pass | Ejection | 1200 | None | 45 |
| 10 | 1pass | Roller | 900 | Yes | 30 |
| 11 | 2pass | Ejection | 900 | Yes | 30 |

(Image Unevenness)

The image recorded as mentioned above was placed in an environment of a temperature of 23° C. and a relative humidity of 50% for 24 hours. Thereafter, the image was taken using a scanner (trade name “OFFIRIO ES-10000G”, manufactured by Seiko Epson Corporation) under the conditions of mode: professional, resolution: 300 dpi and color: 24 bit. Using an image/photograph editing software (trade name “Adobe Photoshop”, manufactured by Adobe Inc.), a range of 200 pixels×200 pixels was converted to a grayscale. A standard image sample (a recorded product in which image unevenness did not occur) was prepared, cut into a size of 50 pixels×100 pixels and pasted on a new clipboard. In the binarization of color tone correction, the threshold value (T) of the binarization boundary was lowered one by one, and the point being in contact with the bottom of the peak was set as the threshold value. Then, the evaluation image sample was cut into a size of 50 pixels×100 pixels and pasted on a new clipboard, and the binarization of color tone correction was carried out. The threshold value (T) determined above was used as the threshold value of the binarization boundary, and the ratio was determined from the histogram. The image unevenness was evaluated from the average value of the histogram ratios with respect to two recording mediums, according to the evaluation criteria described below.
AAA: Average value of the histogram ratios was 99.8 or more.
AA: Average value of the histogram ratios was 99.7 or more to less than 99.8.
A: Average value of the histogram ratios was 99.6 or more to less than 99.7.
B: Average value of the histogram ratios was 99.5 or more to less than 99.6.
C: Average value of the histogram ratios was less than 99.5.

TABLE 6-1
Evaluation condition and evaluation result

| | | Set of aqueous ink and | | | | | |
|---|---|---|---|---|---|---|---|
| | | reaction liquid | | | | | Evaluation |
| | | | | Value of | Evaluation condition | | result |
| | | Reaction | | R/I | Recording | Recording | Image |
| | | liquid | Ink | (times) | condition | Medium | unevenness |
| Example | 1 | 1 | 1 | 20.1 | 1 | 1 · 2 | AA |
| | 2 | 2 | 1 | 20.1 | 1 | 1 · 2 | B |
| | 3 | 3 | 1 | 20.1 | 1 | 1 · 2 | A |
| | 4 | 4 | 1 | 20.1 | 1 | 1 · 2 | AAA |
| | 5 | 5 | 1 | 18.8 | 1 | 1 · 2 | A |
| | 6 | 6 | 1 | 20.1 | 1 | 1 · 2 | AA |
| | 7 | 7 | 1 | 18.2 | 1 | 1 · 2 | AA |
| | 8 | 8 | 1 | 20.0 | 1 | 1 · 2 | A |
| | 9 | 9 | 1 | 2.3 | 1 | 1 · 2 | A |
| | 10 | 10 | 1 | 20.0 | 1 | 1 · 2 | AA |
| | 11 | 11 | 1 | 20.0 | 1 | 1 · 2 | AA |
| | 12 | 12 | 1 | 20.0 | 1 | 1 · 2 | AA |
| | 13 | 13 | 1 | 20.1 | 1 | 1 · 2 | A |
| | 14 | 14 | 1 | 20.1 | 1 | 1 · 2 | AA |
| | 15 | 15 | 1 | 20.1 | 1 | 1 · 2 | AA |
| | 16 | 16 | 1 | 20.1 | 1 | 1 · 2 | A |
| | 17 | 17 | 1 | 18.6 | 1 | 1 · 2 | A |
| | 18 | 18 | 1 | 18.8 | 1 | 1 · 2 | AA |
| | 19 | 19 | 1 | 42.0 | 1 | 1 · 2 | AA |
| | 20 | 20 | 1 | 42.8 | 1 | 1 · 2 | A |
| | 21 | 21 | 1 | 0.9 | 1 | 1 · 2 | A |
| | 22 | 22 | 1 | 2.0 | 1 | 1 · 2 | A |
| | 23 | 23 | 1 | 45.0 | 1 | 1 · 2 | A |
| | 24 | 1 | 1 | 20.1 | 2 | 1 · 2 | AA |
| | 25 | 1 | 1 | 20.1 | 3 | 1 · 2 | AA |

TABLE 6-2
Evaluation condition and evaluation result

| | | Set of aqueous ink and | | | | | |
|---|---|---|---|---|---|---|---|
| | | reaction liquid | | | | | |
| | | | | Value of | Evaluation condition | | |
| | | Reaction | | R/I | Recording | Recording | Evaluation result |
| | | liquid | Ink | (times) | condition | Medium | Image unevenness |
| Example | 26 | 1 | 1 | 20.1 | 4 | 1 · 2 | A |
| | 27 | 1 | 1 | 20.1 | 5 | 1 · 2 | A |
| | 28 | 1 | 1 | 20.1 | 6 | 1 · 2 | AA |
| | 29 | 1 | 1 | 20.1 | 7 | 1 · 2 | AA |
| | 30 | 1 | 1 | 20.1 | 8 | 1 · 2 | A |
| | 31 | 1 | 2 | 40.3 | 1 | 1 · 2 | AA |
| | 32 | 1 | 3 | 20.1 | 1 | 1 · 2 | AA |
| | 33 | 1 | 4 | 20.1 | 1 | 1 · 2 | AA |
| | 34 | 1 | 5 | 20.1 | 1 | 1 · 2 | AA |
| | 35 | 1 | 6 | 20.1 | 1 | 1 · 2 | AA |
| | 36 | 24 | 1 | 0.9 | 9 | 1 · 2 | B |
| Reference | 1 | 1 | 1 | 20.1 | 10 | 1 · 2 | AA |
| example | 2 | 25 | 1 | 20.1 | 10 | 1 · 2 | AA |
| | 3 | 1 | 1 | 20.1 | 11 | 1 · 2 | AA |
| | 4 | 25 | 1 | 20.1 | 11 | 1 · 2 | AA |
| | 5 | 1 | 1 | 20.1 | 1 | 3 · 4 | AA |
| | 6 | 25 | 1 | 20.1 | 1 | 3 · 4 | AA |
| | 7 | 1 | 1 | 20.1 | 1 | 5 · 6 | AA |
| | 8 | 25 | 1 | 20.1 | 1 | 5 · 6 | AA |
| Comparative | 1 | 26 | 1 | 23.2 | 1 | 1 · 2 | C |
| Example | 2 | 27 | 1 | 23.7 | 1 | 1 · 2 | C |
| | 3 | 28 | 1 | 18.2 | 1 | 1 · 2 | C |
| | 4 | 25 | 1 | 20.1 | 1 | 1 · 2 | C |
| | 5 | 29 | 1 | 20.1 | 1 | 1 · 2 | C |
| | 6 | 30 | 1 | 9.5 | 1 | 1 · 2 | C |

According to the present invention, there can be provided the ink jet recording method capable of recording an image with suppressed unevenness when an image is recorded on a low absorbable recording medium by a single pass system. In addition, according to the present invention, the ink jet recording apparatus can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-188258, filed Nov. 25, 2022, and Japanese Patent Application No. 2023-177417, filed Oct. 13, 2023, which are hereby incorporated by reference herein in their entirety.

What is claimed is:

1. An ink jet recording method for recording an image on a recording medium having a water absorption amount of 4 mL/m² or more to 10 mL/m² or less from a start of contact to 30 msec^{1/2} in a Bristow method, using an aqueous ink, and an aqueous reaction liquid containing a reactant reacting with the aqueous ink by carrying out application of the aqueous ink and the reaction liquid to a unit region by one relative scan between an ejection head of an ink jet system and the recording medium, the method comprising:
an ink applying step to apply the reaction liquid to the recording medium, and
a reaction liquid applying step to apply the aqueous ink to the recording medium so that a region to which the aqueous ink is applied and a region to which the reaction liquid is applied are at least partially overlap on the recording medium, wherein
the aqueous ink contains a pigment,
the reaction liquid contains a cationic resin having a structure of a quaternary ammonium salt, and a surface tension of a liquid obtained by replacing a surfactant in the reaction liquid with water at 25° C. is 60 mN/m or more.

2. The ink jet recording method according to claim 1, wherein a weight average molecular weight of the cationic resin is 4,000 or more.

3. The ink jet recording method according to claim 1, wherein the structure of the quaternary ammonium salt of the cationic resin is a unit represented by the following general formula (1): 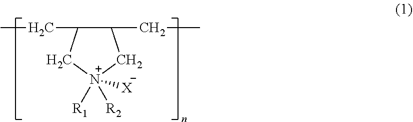
wherein R₁ and R₂ each independently represent an alkyl group, X⁻ represents a counter anion of a quaternary ammonium cation, and n represents the number of repeating unit.

4. The ink jet recording method according to claim 1, wherein the reaction liquid contains a polyvalent metal salt.

5. The ink jet recording method according to claim 1, wherein the surface tension of the reaction liquid at 25° C. is 23 mN/m or more to 35 mN/m or less.

6. The ink jet recording method according to claim 1, wherein a viscosity of the reaction liquid at 25° C. is 1.5 mPa·s or more to 2.7 mPa·s or less.

7. The ink jet recording method according to claim 1, wherein a ratio of an amount (mmol/g) of a cationic group in the reaction liquid to an amount (mmol/g) of an anionic group of the pigment in the aqueous ink is 2.0 or more.

8. The ink jet recording method according to claim 1, wherein a time from application of the reaction liquid to the recording medium in the reaction liquid applying step to application of the aqueous ink to the recording medium in the ink applying step is 1,100 msec or less.

9. The ink jet recording method according to claim 1, comprising a drying step to dry the recording medium to which the reaction liquid and the aqueous ink are applied, using a heating device.

10. The ink jet recording method according to claim 9, wherein a drying unit in the drying step is warm air having an air speed of 40 m/s or less.

11. An ink jet recording apparatus used for an ink jet recording method for recording an image on a recording medium having a water absorption amount of 4 mL/m² or more to 10 mL/m² or less from a start of contact to 30 msec^{1/2} in a Bristow method, using an aqueous ink, and an aqueous reaction liquid containing a reactant reacting with the aqueous ink by carrying out application of the aqueous ink and the reaction liquid to a unit region by one relative scan between an ejection head of an ink jet system and the recording medium, wherein
the ink jet recording method comprises an ink applying step to apply the reaction liquid to the recording medium, and a reaction liquid applying step to apply the aqueous ink to the recording medium so that a region to which the aqueous ink is applied and a region to which the reaction liquid is applied are at least partially overlap on the recording medium,
the aqueous ink contains a pigment,
the reaction liquid contains a cationic resin having a structure of a quaternary ammonium salt, and a surface tension of a liquid obtained by replacing a surfactant in the reaction liquid with water at 25° C. is 60 mN/m or more.
